(19) United States
(12) Patent Application Publication
(10) Pub. No.: US 2009/0164954 A1
(43) Pub. Date: Jun. 25, 2009

(54) AUTOMATIC ANTENNA DESIGNING APPARATUS AND AUTOMATIC ANTENNA DESIGNING METHOD

(75) Inventors: Takashi Yamagajo, Kawasaki (JP); Makoto Mukai, Hachioji (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/337,822

(22) Filed: Dec. 18, 2008

(30) Foreign Application Priority Data
Dec. 21, 2007 (JP) 2007-331102
Aug. 14, 2008 (JP) 2008-209024

(51) Int. Cl. G06F 17/50

(52) U.S. Cl. 716/2; 716/1

(57) ABSTRACT

An automatic antenna designing apparatus for designing a tag antenna of an IC tag, has a model storage unit configured to store models serving as templates of the tag antenna to be designed; and a design input unit configured to read out a model from the model storage unit on the basis of a designer's instruction, to display the read out model on a screen, and to display an input screen allowing the designer to input a change in a shape of the model as length information.

### CROSS-REFERENCE TO RELATED APPLICATION

This application is based upon and claims the benefit of priority of the prior Japanese Patent Application No. 2007-331102, filed on Dec. 21, 2007, and No. 2008-209024, filed on Aug. 14, 2008, the entire contents of which are incorporated herein by reference.

### FIELD

The present invention relates to an automatic antenna designing apparatus, an automatic antenna designing method, and a computer-readable storage medium storing a program for designing tag antennas. The apparatus, the method, and the storage medium include a technique capable of easily designing efficient tag antennas.

### BACKGROUND

Currently, the use of radio communication IC tags, such as a Radio Frequency Identification (RFID) tag and a contactless IC card, is increasing. In addition, various proposals are made regarding a design of such tag antennas.

Japanese Laid-open Patent Application Publication No. 2005-45339 discloses a method for designing a tag antenna capable of stably obtaining electric power and guaranteeing a sufficient communication distance. More specifically, an antenna is designed to resonate with a radio wave transmitted from a reader/writer (RW) for reading and writing data from and to an IC tag and to have impedance that matches impedance of an input unit of a tag LSI to be connected to the tag antenna.

In addition, Japanese Laid-open Patent Application Publication No. 2005-33500 discloses a designing method that reduces the time needed for designing a tag antenna by calculating electrical characteristics of the tag antenna after determination of a frequency.

Furthermore, Japanese Laid-open Patent Application Publication No. 2005-244283 discloses a shape of an IC tag antenna that improves the non-directivity and realizes easier impedance matching.

Additionally, Japanese Laid-open Patent Application Publication No. 2003-332814 discloses a method for making antenna designing easier by dividing an analysis-target area of the antenna into small components, defining a variable for each component, and changing and optimizing this variable.

Utilization of electromagnetic field simulators is effective in designing tag antennas of IC tags. However, since an operation method of general-purpose electromagnetic field simulators is complicated due to their advanced functions, users take some time to learn the complicated operation method.

Additionally, in general, impedance of a tag LSI of an IC tag is equal to “(several tens) Q−j (several hundreds) Ω”, where “j” is an imaginary unit. A tag antenna having impedance that matches such impedance is designed.

However, the general-purpose electromagnetic field simulators often do not have a function for evaluating matching between impedance of the antenna and reference impedance represented in a complex number format.

Additionally, when a designer performs modeling of a tag antenna, the designer inputs a size of the antenna on a modeling screen. This input work corresponds to movement of dots that define a shape of the tag antenna on the screen. As the shape of the antenna becomes more complicated, the input work becomes more troublesome and takes more time.

Furthermore, functions essential in designing an IC tag are those regarding a communication distance, a frequency band, and a radiation pattern. However, general-purpose electromagnetic field simulators are incapable of calculating and displaying the communication distance. Accordingly, a designer separately calculates the communication distance on the basis of calculated gain and impedance values obtained with the general-purpose electromagnetic field simulators.

In addition, to design an IC tag providing optimum performance, a designer searches for a condition where an optimum value is obtained while changing parameters affecting the performance of the IC tag. Accordingly, since the above-described processes of creation of a model, matching, and evaluation of a communication distance are repeated over and over, significant time and effort are undesirably required.

### SUMMARY

In view of the above-described circumstance, an automatic antenna designing apparatus allowing even designers without special knowledge and experience to easily design efficient tag antennas, an automatic antenna designing method, and a computer-readable storage medium storing a program are provided.

According to an aspect of the embodiments, an automatic antenna designing apparatus for designing a tag antenna of an IC tag has a model storage unit configured to store models serving as templates of the tag antenna to be designed, and has a design input unit configured to read out a model from the model storage unit on the basis of a designer's instruction, to display the read out model on a screen, and to display an input screen allowing the designer to input a change in a shape of the model as length information.

Additional objects and advantages of the embodiment will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a diagram illustrating an example of a configuration of an automatic antenna designing apparatus according to an embodiment;

FIG. 2 illustrates an example screen displayed by a design input unit;

FIG. 3 is a diagram illustrating an example model of a created tag antenna;

FIG. 4 illustrates an input screen displayed by a matching state calculating unit;

FIG. 5 is a diagram illustrating an equivalent circuit of a tag LSI;

FIG. 6 is a diagram illustrating an example of a result calculated by a matching state calculating unit on a Smith chart;

FIG. 7 is a diagram illustrating a frequency characteristic with respect to a communication distance of a model of a designed tag antenna displayed by a communication distance characteristic calculating unit;

FIG. 8 is a diagram illustrating a directivity distribution with respect to a communication distance at a specific frequency displayed by a communication distance characteristic calculating unit;

FIG. 9 is a diagram illustrating an example of an antenna optimally designed by an antenna optimum value calculating unit;

FIGS. 10A to 10D are diagrams illustrating simulation results obtained when a length L1 is fixed and a length S2 is changed;

FIG. 11 illustrates an example in which a length S2 of a tag antenna is changed in a range between P1 and P4;

FIGS. 12A and 12B are diagrams illustrating examples of optimization processing execution screens displayed by an antenna optimum value calculating unit;

FIG. 13 is a flowchart illustrating an operation of an automatic antenna designing apparatus performed at the time of designing a tag antenna;

FIG. 14 is a flowchart illustrating an operation of optimization processing;

FIG. 15 is a diagram illustrating a first example of a tag antenna automatically designable by optimizing a plurality of values;

FIG. 16 is a diagram illustrating a second example of a tag antenna automatically designable by optimizing a plurality of values;

FIG. 17 is a diagram illustrating a third example of a tag antenna automatically designable by optimizing a plurality of values;

FIGS. 18A and 18B are diagrams illustrating a locus of impedance of a tag antenna on the Smith chart obtained when the tag antenna is designed on the basis of a communication distance and a frequency band, respectively;

FIGS. 19A and 19B are enlarged views of FIGS. 18A and 18B;

FIGS. 20A and 20B are diagrams illustrating examples of optimization processing execution screens displayed by an antenna optimum value calculating unit when a plurality of lengths defining a tag antenna are optimized;

FIG. 21 is a flowchart illustrating an operation of an automatic antenna designing apparatus performed when a plurality of lengths defining a tag antenna are simultaneously optimized;

FIG. 22 is a flowchart (part 1) illustrating an operation for determining a plurality of values defining a shape of a tag antenna by performing optimization processing for one parameter a plurality of times;

FIG. 23 is a flowchart (part 2) illustrating an operation for determining a plurality of values defining a shape of a tag antenna by performing optimization processing for one parameter a plurality of times;

FIG. 24 is a system environment diagram of an automatic antenna designing apparatus; and

FIG. 25 is a diagram illustrating examples of a storage medium.

### DESCRIPTION OF THE EMBODIMENTS

An embodiment of an automatic antenna designing apparatus to be disclosed will be described below with reference to the drawings.

An example case where tag antennas of RFID tags of the UHF band and the 2.45 GHz band are designed with an automatic antenna designing apparatus according to an embodiment is illustrated in a description given below. However, the tag antennas that can be designed with the automatic antenna designing apparatus according to this embodiment are not limited to such a kind, and tag antennas of RFID tags of other frequency bands and tag antennas of ID tags other than the RFID, such as a contactless IC card, can be designed.

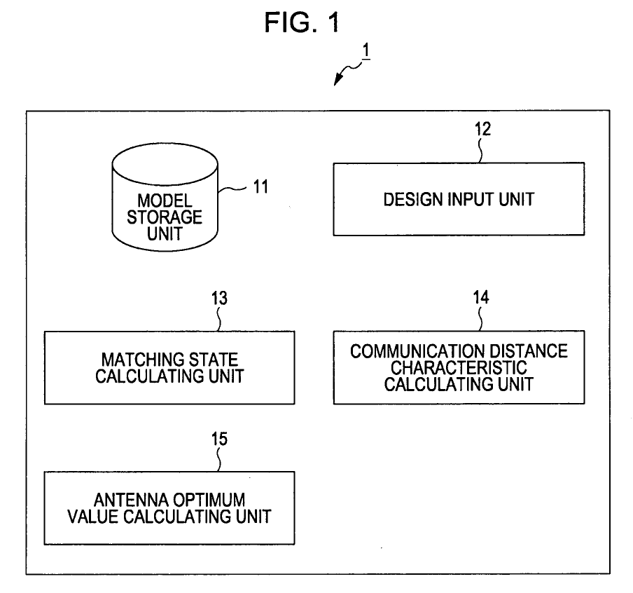

FIG. 1 is a diagram illustrating an example of a configuration of an automatic antenna designing apparatus according to an embodiment.

Referring to FIG. 1, an automatic antenna designing apparatus 1 includes a model storage unit 11, a design input unit 12, a matching state calculating unit 13, a communication distance characteristic calculating unit 14, and an antenna optimum value calculating unit 15.

The model storage unit 11 stores models serving as templates when a tag antenna is designed with the automatic antenna designing apparatus 1 and previously designed models. This model information includes information regarding coordinates of dots that define a shape of the tag antenna and an electrical characteristic of the tag antenna. Meanwhile, the model information stored in this model storage unit 11 is basically the same as data of tag antennas designed by conventional designing apparatuses. Thus, the design data of other designing apparatuses may be copied in this model storage unit 11 and used as the templates when the tag antenna is designed with the automatic antenna designing apparatus 1 according to this embodiment.

The design input unit 12 displays a model read out from the model storage unit 11 on a display unit and allows a designer to input and change information regarding lengths of parts defining a shape at the time of designing a tag antenna. The designer specifies and inputs the lengths of parts that the designer wants to change from the shape of the tag antenna displayed by the design input unit 12. On the basis of the input lengths, the design input unit 12 changes the coordinates of the dots defining the shape of the tag antenna to create a model having a new shape. In addition, the design input unit 12 analyzes the designed tag antenna and determines impedance (admittance) and gain of the tag antenna.

By allowing the designer to input the change in the shape of the tag antenna as information regarding the lengths in this manner, the shape of the tag antenna is easily changed and designed in the automatic antenna designing apparatus 1 according to this embodiment.

The matching state calculating unit 13 calculates a matching state of impedance of a tag LSI and impedance of the tag antenna designed by the design input unit 12, and displays the calculation result on a screen.

The communication distance characteristic calculating unit 14 calculates a frequency characteristic and a directivity distribution with respect to a communication distance of the tag antenna designed by the design input unit 12, and displays the calculation result.

The antenna optimum value calculating unit 15 calculates an optimized length of a specific part and displays the calculation result when the tag antenna is designed by the design input unit 12.

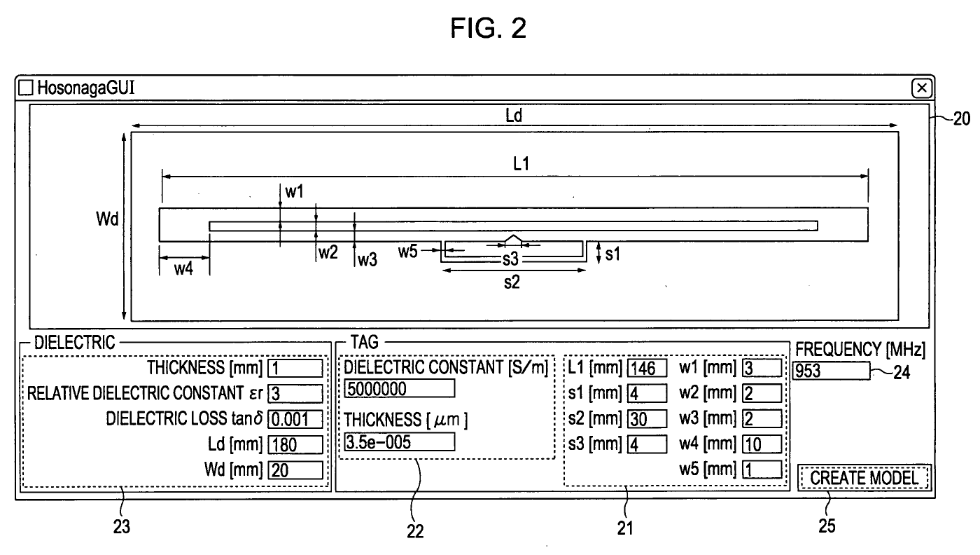

FIG. 2 is an example screen displaying a model read out from the model storage unit 11 by the design input unit 12.

FIG. 2 illustrates an example of a model read out to design a tag antenna in which a parallel inductance pattern is attached to a folded dipole antenna.

As illustrated in FIG. 2, a shape of a displayed tag antenna is defined by 9 kinds of length information, namely, L1, S1 to S3, and W1 to W5. In response to the designer's input of each desired length at an input block 21, the shape of the tag antenna displayed on a display screen 20 changes.

In conventional tag antenna design, the shape of the tag antenna is designed by changing three-dimensional coordinates of a plurality of shape-defining dots on an electromagnetic field simulator screen. Accordingly, even skilled people take several minutes to several tens of minutes to perform processing for changing the size of a specific part. On the contrary, the designer can instantly change the shape of the tag antenna in the automatic antenna designing apparatus 1 according to this embodiment by inputting the desired length at the input block 21.

Meanwhile, the designer can change a setting of an electrical characteristic of the tag antenna by inputting values at an input block 22 on the design screen illustrated in FIG. 2. In addition, the designer can set a size and an electrical characteristic of a material (dielectric) to which the tag antenna is adhered and a target frequency by inputting values at the input blocks 23 and 24.

Generally, the tag antenna is adhered to some kind of control target. Since the adhesion changes the characteristic of the antenna, modeling of an adhesion target is also needed. Accordingly, when the characteristic of the tag antenna alone is evaluated before the adhesion, modeling of the adhesion-target dielectric is not required.

The designer inputs necessary sizes and material characteristics at the input blocks 21, 22, 23, and 24, and presses a create model button 25 arranged, for example, in a lower right part of the screen by operating a pointing device, thereby creating a model analyzable by an electromagnetic field simulator. After all the inputting and designing is completed, data of the designed tag antenna is stored in the model storage unit 11 in response to the designer pressing a store button on the screen (not shown). Needless to say, the stored model may be used as a template when another tag antenna is designed.

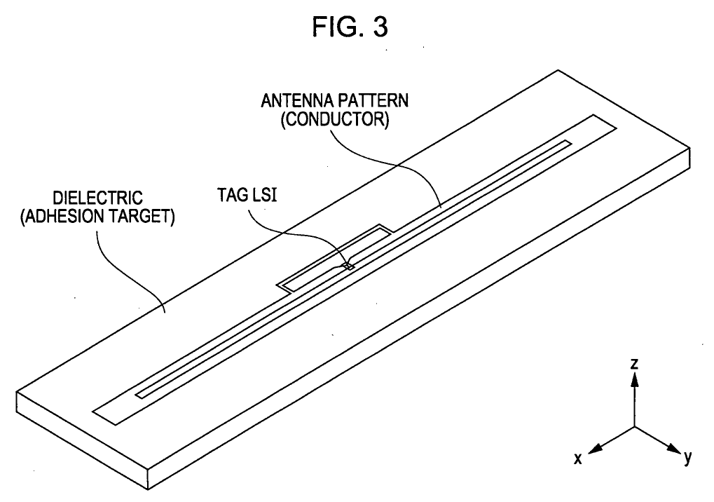

FIG. 3 illustrates an example model of a tag antenna created in the above-described processing.

When modeling of this tag antenna is performed from the start using a conventional general-purpose electromagnetic field simulator, the designer has to input three-dimensional coordinates of each dot defining the shape. Even skilled people take approximately ten minutes to input the coordinates. However, if the automatic antenna designing apparatus 1 according to this embodiment is used, non-skilled people can create a model illustrated in FIG. 3 in several seconds to several tens of seconds. Accordingly, the automatic antenna designing apparatus 1 can significantly improve the efficiency.

Regarding an overview of an operation principle of the tag antenna, in which a parallel inductance pattern is attached to a folded dipole antenna, illustrated in FIG. 3, Japanese Unexamined Patent Application Publication No. 2006-295879 describes a detail of the operation of a similar tag antenna.

In addition, the tag antenna in which a parallel inductance pattern is attached to a folded dipole antenna is used as a template in the example illustrated in FIG. 2. However, the model storage unit 11 prepares other configurations, e.g., templates of tag antennas of a type in which a parallel inductance pattern is attached to a dipole antenna whose entire length is equal to or smaller than a half-wavelength, and tag antennas of other types such as a patch antenna. The model of the tag antenna may be designed using these templates.

Additionally, a characteristic of the created model may be simulated by the designer's pressing of an “analyze” button provided on the screen illustrated in FIG. 2. Furthermore, a “display result” button may be provided so that the analysis result can be displayed. In addition, these buttons may be integrated into a “create/analyze model” button.

Meanwhile, the analysis method may be any conventional and proven electromagnetic field analyzing method and is not limited particularly. For example, a method of moment, a Finite Difference Time Domain (FDTD) method, or a finite element method may be employed.

An operation of the matching state calculating unit 13 will now be described.

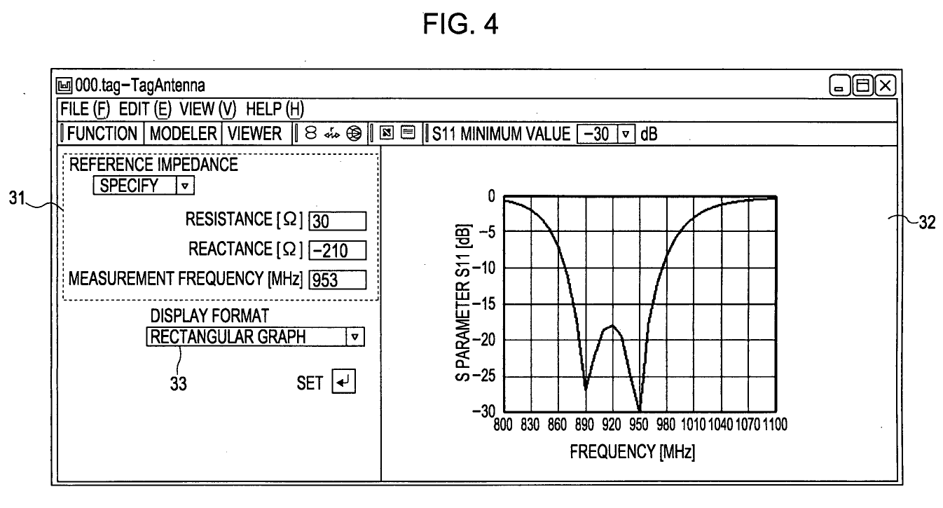

FIG. 4 is an input screen displayed by the matching state calculating unit 13.

On the displayed input screen illustrated in FIG. 4, an input block 31 for receiving input of impedance and a measurement frequency of a tag LSI is arranged on the left. In response to the designer entering the input impedance of the tag LSI that calculates matching into the input block 31, matching between the impedance of the tag LSI and that of the tag antenna designed by the design input unit 12 is calculated and the calculation result is displayed as a graph in a display part 32. FIG. 4 illustrates a graph whose vertical axis and horizontal axis represent an S parameter S11 (input reflection coefficient) and a frequency, respectively. The parameter S11 becomes minimum at around the measurement frequency of 953 MHz, which reveals that the matching is substantially realized.

A condition for realizing the matching between the tag LSI and the tag antenna will now be described.

Suppose that impedance Zc of the tag LSI is represented as follows.

Zc=Rc+jXc (1)

The subscript “c” of Equation (1) represents the initial of “chip”, whereas “j” represents the imaginary unit.

In Equation (1), impedances Rc and Xc of a general tag LSI are represented as:

Rc=several tens Ω, Xc=−several hundreds Ω (2)

General antennas are often designed to have impedance that matches 50Ω, 75Ω, or 300Ω. However, the real part of the impedance of the tag LSI is not equal to any of the above values and the imaginary part Xc is not equal to 0.

In addition, impedance Za of the tag antenna is defined as follows.

Za=Ra+jXa (3)

The subscript “a” of Equation (3) represents the initial of “antenna.”

To make the impedance of the tag antenna match the impedance of the tag LSI, the following relation has to be satisfied.

Zc=Za* (4)

In Equation (4), “Za*” means a complex conjugate of “Za.”

Accordingly, the condition for realizing the matching of the tag antenna and the tag LSI can be revised as follows.

Rc=Ra, Xc=−Xa (5)

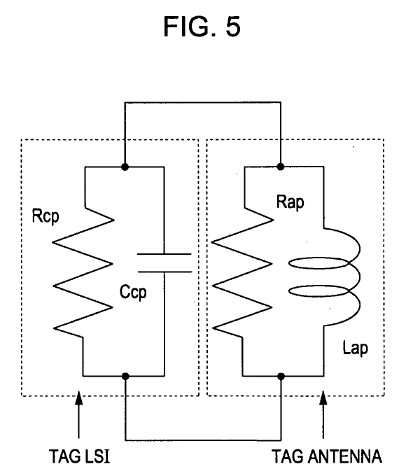

Here, as illustrated in FIG. 5, an equivalent circuit of the tag LSI can be considered as a circuit including a resistor (Rcp) and a capacitor (Ccp) connected in parallel to the resistor (Rcp). An equivalent circuit of the tag antenna can be considered as a circuit including a resistor (Rap) and an inductor (Lap) connected in parallel to the resistor (Rap). The subscript “p” of FIG. 5 represents a parallel circuit.

Since the use of admittance makes understanding easier than using impedance to represent the parallel circuit illustrated in FIG. 5, Equations (1) and (3) are converted into the admittance. First, the admittance of the tag LSI is represented as follows.

$$\begin{matrix}\begin{matrix}Yc = \frac{1}{Zc} \\ = \frac{1}{Rc + jXc} \\ = \frac{Rc}{{Rc}^{2} + {Xc}^{2}} - j \frac{Xc}{{Rc}^{2} + {Xc}^{2}} \\ ≡ Gcp + jBcp\end{matrix} & ( 6 )\end{matrix}$$

In Equation (6), “Gcp” represents parallel conductance of the tag LSI, whereas “Bcp” represents parallel susceptance of the tag LSI.

Since admittance of a tag capacitance component C is represented as “j·C” (where, “·” represents an angular frequency), the “Rcp” and “Ccp” are represented as follows on the basis of Equation (5) and FIG. 5.

$$Rcp = \frac{Rc}{{Rc}^{2} + {Xc}^{2}} \\ Ccp = - \frac{1}{ω} \frac{Xc}{{Rc}^{2} + {Xc}^{2}} \qquad ( 7 )$$

Here, admittance of a tag antenna will now be discussed. Since admittance of an inductance component L is represented as “1/(j·L),” the “Rap” and “Lap” are represented as follows as in the case of the tag LSI.

$$\begin{matrix}\begin{matrix}Ya = \frac{1}{Za} \\ = \frac{1}{Ra + jXa} \\ = \frac{Ra}{{Ra}^{2} + {Xa}^{2}} - j \frac{Xa}{{Ra}^{2} + {Xa}^{2}} \\ ≡ Gap + jBap\end{matrix} & ( 8 )\end{matrix}$$

Here, the “Gap” and “Bap” represent parallel conductance and parallel susceptance of the tag antenna, respectively.

When the matching condition of Equation (5) is applied to Equation (7) and Equation (8), Equation (9) is obtained.

$$Rap = \frac{Ra}{{Ra}^{2} + {Xa}^{2}} = \frac{Rc}{{Rc}^{2} + {( - Xc )}^{2}} = Rcp \\ Lap = \frac{1}{ω} \frac{{Ra}^{2} + {Xa}^{2}}{Xa} = \frac{1}{ω} \frac{{Rc}^{2} + {( - Xc )}^{2}}{( - Xc )} = \frac{1}{{ω}^{2} Ccp} \qquad ( 9 )$$

Here, when Equation (9) is satisfied, “Bap” becomes equal to “−Bcp” (Bap=−Bcp) and “Ya” becomes equal to “Yc*” (Ya=Yc*).

More specifically, by setting the parallel resistance component Rap of the tag antenna equal to the parallel resistance component Rcp of the tag LSI, and by canceling the parallel capacitance component Ccp of the tag LSI with the parallel inductance component Lap of the tag antenna, the matching is realized.

Since the imaginary part of the admittance of the tag LSI is represented as “Ccp·ω,” the imaginary part changes in accordance with the frequency. That is, the impedance differs for each frequency.

A normal electromagnetic field simulator cannot display the matching state of such complex reference impedance. Although the designer may know the overview matching state by plotting the impedance on the Smith chart, the matching state displayed in a rectangular graph as illustrated in FIG. 4 is more easily understandable than that displayed in the Smith chart in order to quantitatively evaluate the matching state.

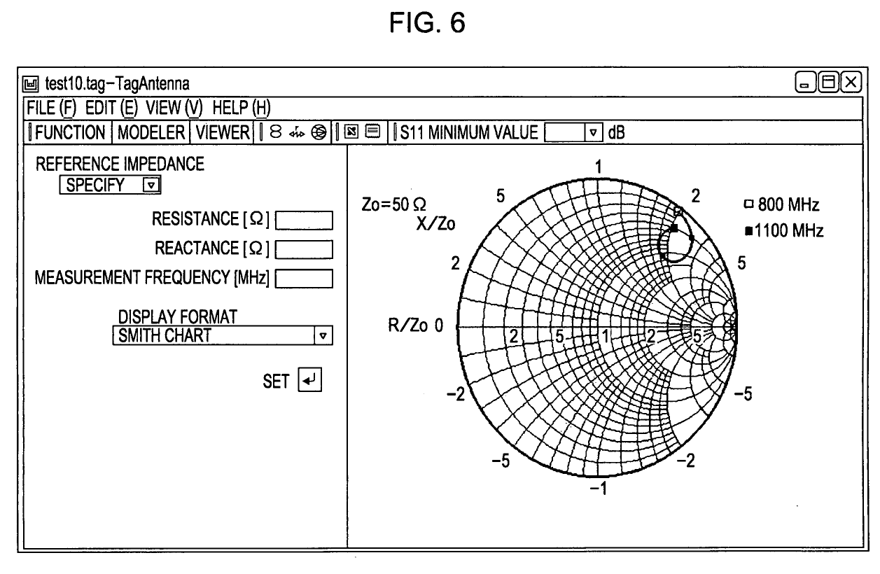

The automatic antenna designing apparatus 1 according to this embodiment may display the result of calculation performed by the matching state calculating unit 13 using the Smith chart as illustrated in FIG. 6 as well as a graph as illustrated in FIG. 4.

FIG. 6 illustrates a calculation result at frequencies between 800 MHz and 1200 MHz displayed on the Smith chart.

An operation performed by the communication distance characteristic calculating unit 14 will now be described.

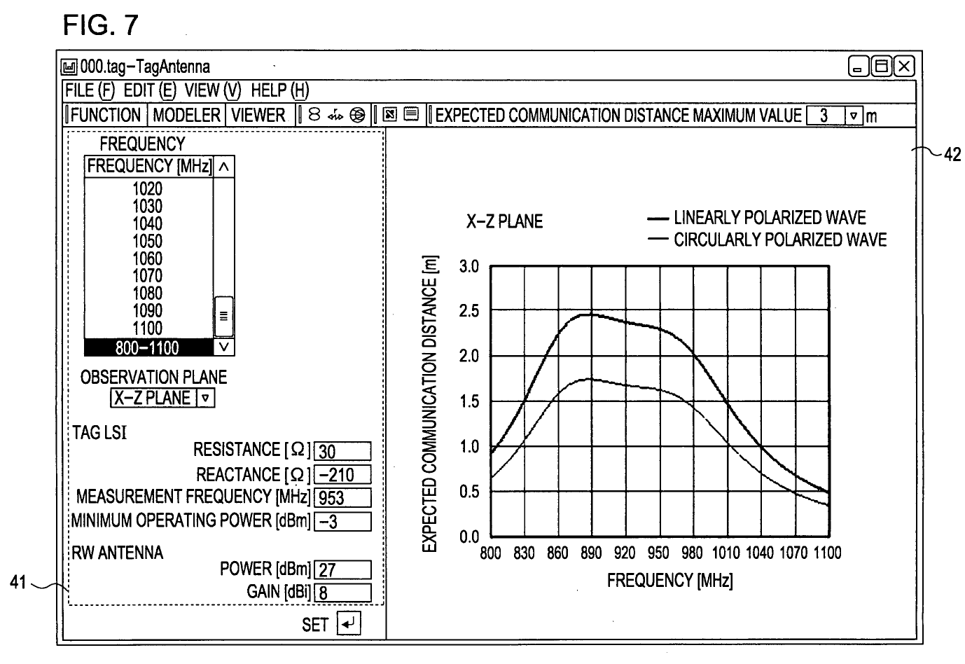

FIG. 7 is a diagram illustrating a frequency characteristic with respect to a communication distance of a designed tag antenna model displayed by the communication distance characteristic calculating unit 14.

Referring to FIG. 7, in response to the designer inputting a calculation-target frequency range, an electrical characteristic of a tag LSI, output power, and gain of a reader/writer (RW) at an input block 41, the communication distance of the designed tag antenna for each frequency is calculated and a graph whose vertical axis and horizontal axis represent an expected communication distance and a frequency, respectively, is displayed on a display screen 42. In the case of FIG. 7, the communication distance reaches its high point at around a frequency of 870 MHz.

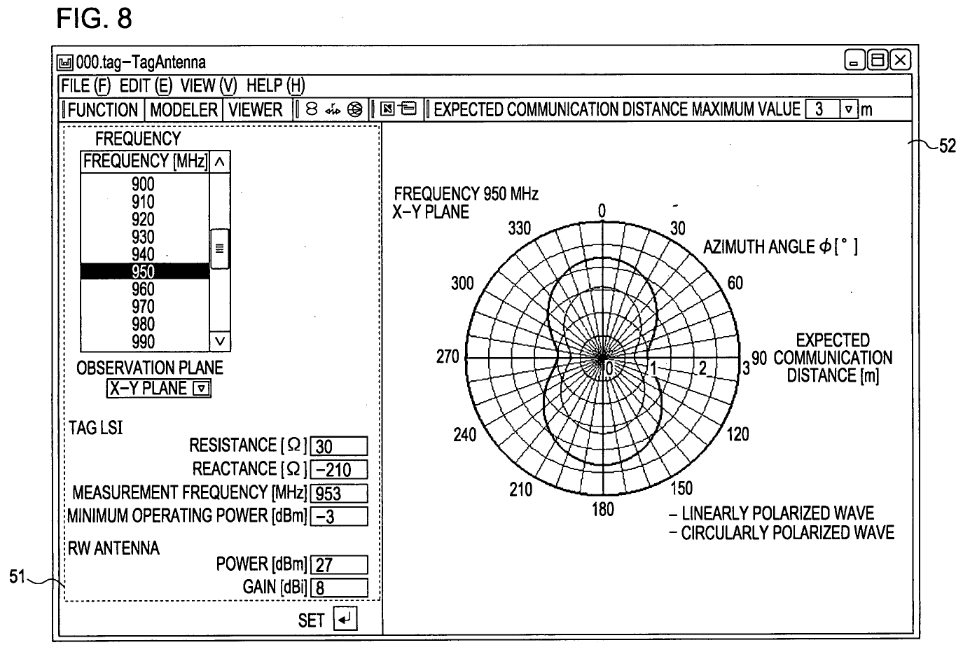

FIG. 8 is a diagram illustrating a directivity distribution with respect to a communication distance at a specific frequency displayed by the communication distance characteristic calculating unit 14.

In response to the designer selecting an electrical characteristic of the tag LSI and a characteristic of the reader/writer (RW) at an input block 51 arranged, for example, at the left part of a screen, a diagram illustrating a directivity distribution of the designed tag antenna model is displayed on a display screen 52.

Since a conventional general-purpose electromagnetic field simulator does not have a function of this communication distance characteristic calculating unit 14, the designer has to separately process the calculation result of the electromagnetic field simulator using a spreadsheet tool or the like to calculate the communication distance. In contrast, since the automatic antenna designing apparatus 1 according to this embodiment can determine calculation results regarding the communication distance and the directivity of the designed tag antenna using the communication distance characteristic calculating unit 14, time needed for evaluation of the communication distance can be considerably reduced.

The communication distance is calculated on the basis of Equation (10) given below.

$$r = \frac{λ}{4 π} \sqrt{\frac{{P}_{t} {G}_{t} {G}_{r} q}{Pth}} \qquad ( 10 )$$

In Equation (10), “λ,” “Pₜ,” “Gₜ,” q, Pth, and Gᵣ represent a wavelength, output power of a reader/writer (RW), antenna gain of the reader/writer (RW), a matching coefficient, minimum operating power of a tag LSI, and gain of a tag antenna, respectively.

In Equation (10), the matching coefficient q of the tag LSI and the tag antenna is represented as Equation (11) given below.

$$q = \frac{4 RcRa}{{\vert Zc + Za \vert}^{2}} \qquad ( 11 )$$

In Equation (11), the reactance Zc is represented as Zc=Rc+jXc, where “Rc” and “Xc” represent the resistance of the tag LSI, whereas the reactance Za is represented as Za=Ra+jXa, where “Ra” and “Xa” represent the resistance of the tag antenna.

The communication distance determined using Equations (10) and (11) is the communication distance where a polarization characteristic of an antenna of the reader/writer (RW) is linear. When the antenna of the reader/writer (RW) radiates a circularly polarized wave, the communication distance is determined by dividing the calculation result obtained with Equation (10) by \sqrt{2}.

An operation of the antenna optimum value calculating unit 15 will now be described.

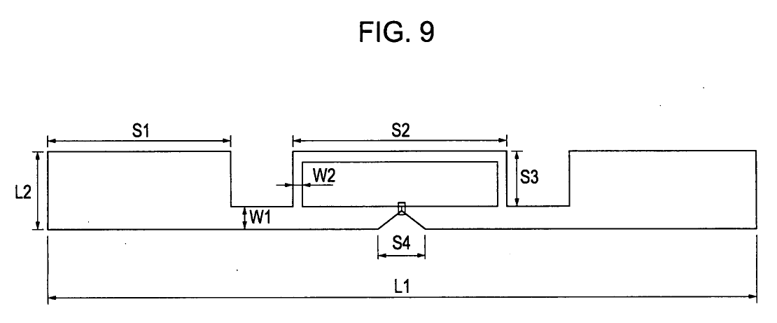

FIG. 9 illustrates an example of an antenna optimally designed by the antenna optimum value calculating unit 15.

In the antenna illustrated in FIG. 9, an inductance pattern is attached in parallel to a dipole antenna whose length is substantially equal to or smaller than a half-wavelength. The tag antenna that can be optimized by the antenna optimum value calculating unit 15 is not limited to the shape illustrated in FIG. 9 as long as the inductance pattern is attached in parallel to the dipole antenna whose length is substantially equal to or smaller than a half-wavelength. A detailed operation principle of the tag antenna illustrated in FIG. 9 is disclosed in Japanese Unexamined Patent Application Publication No. 2006-295879.

Generally, the performance (communication distance) of an antenna is determined by an occupied volume of the antenna. Since the size (L1 or L2 in FIG. 9) of the tag antenna is often determined by the size of an adhesion target in general, the designer cannot determine the size of the tag antenna freely in many cases. In addition, since the communication distance of the tag antenna is determined by the matching state of the tag antenna and the tag LSI, the communication distance changes in response to a change in the impedance of the tag antenna, which changes in response to a change in the length S2 illustrated in FIG. 9.

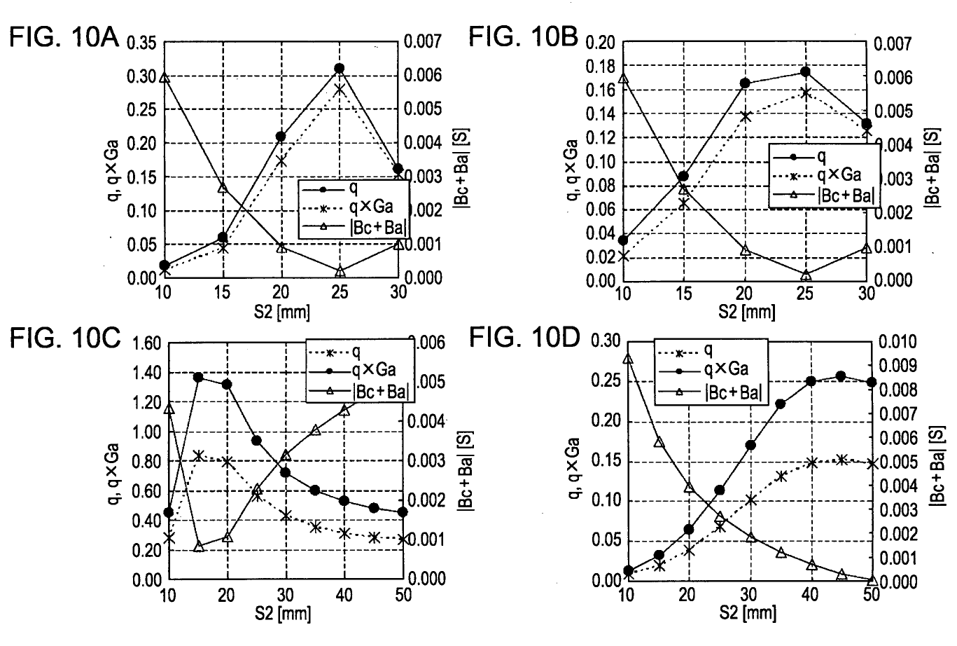

FIGS. 10A to 10D illustrate simulation results obtained when the length S1 is fixed and the length S2 is changed.

FIGS. 10A, 10B, 10C, and 10D illustrate the S2 value at the horizontal axis and three variables, namely, the product (q×Ga: proportional to the communication distance) of the matching coefficient and the gain of the tag antenna, the matching coefficient (q), and a difference (|Bc+Ba|) between susceptance of the tag antenna and susceptance of the tag LSI at the vertical axis when “L1” and “Yc” are set to 73 mm and 1−j4 mS, 73 mm and 2−j4 mS, 150 mm and 1−j4 mS, and 150 mm and 2−j4 mS, respectively.

The parameters L2, W1, W2, S3, and S4 are fixed to 7 mm, 2 mm, 1 mm, 5 mm, and 5 mm, respectively, in FIG. 10.

When the L1 is set to 73 mm as illustrated in FIGS. 10A and 10B, values of the S2 that give the maximum q and q×Ga values and a value of the S2 that gives the minimum |Bc+Ba| value are the same, namely, 25 mm. Accordingly, in these cases, the value of S2 that gives the minimum Bc+Ba, namely, the value of S2 at which Bc=−Ba is satisfied, is determined.

On the other hand, when the L1 is equal to 150 mm as illustrated in FIGS. 10C and 10D, the values of the S2 that give the maximum q and q×Ga values are the same but the value of the S2 that gives the minimum |Bc+Ba| value may differ from the value of the S2 that gives the maximum q value as illustrated in FIG. 10D.

Accordingly, if the exterior size of the tag antenna is determined, the communication distance of the tag antenna can be optimized by changing only the value of the S2.

When the length of the tag antenna is shorter than a wavelength of a reception-target radio wave, an algorithm for determining an S2 value at which a sum of the susceptance of the tag antenna and the susceptance of the tag LSI becomes substantially equal to 0 can be employed to determine an optimum S2 value. On the other hand, when the length of the antenna is close to a half-wavelength (in this case, approximately 15.7 cm) of a reception-target radio wave, an algorithm for determining an S2 value that gives the maximum matching coefficient q (the minimum S11 value) can be employed.

Meanwhile, when the entire length is close to the half-wavelength or is sufficiently shorter than the half-wavelength, the algorithm for determining an S2 value that gives the minimum q may be employed. However, in general, it takes less time to determine a solution using an algorithm for solving a nonlinear first-degree equation than using a minimum value determining algorithm. Accordingly, the antenna optimum value calculating unit 15 employs an algorithm for determining the S2 value that makes the sum of the susceptance of the tag antenna and the susceptance of the tag LSI approximate 0 when the length of the tag antenna is shorter than the wavelength of the reception-target radio wave and employs an algorithm for determining the S2 value that gives the minimum matching coefficient when the length of the antenna is close to the half-wavelength of the reception-target radio wave. By employing different algorithms in accordance with the entire length of the antenna in this manner, a more efficient optimization design is realized.

The golden section method and the Brent's method may be employed as the algorithm of the one dimension minimum value problem. To further increase the accuracy, the following method using a third-degree function may be employed.

### <STEP 1>

The antenna optimum value calculating unit 15 selects four points where S2=P1, S2=P2, S2=P3, and S2=P4 with the horizontal axis S2 and the vertical axis S11 (true value), and approximates a third-degree function passing through these four points. Meanwhile, P1 represents a settable minimum S2 value, whereas P4 represents a maximum value. P2 and P3 may be represented as Equations given below.

P2=P1+1/3(P4−P1)

P3=P1+2/3(P4−P1)

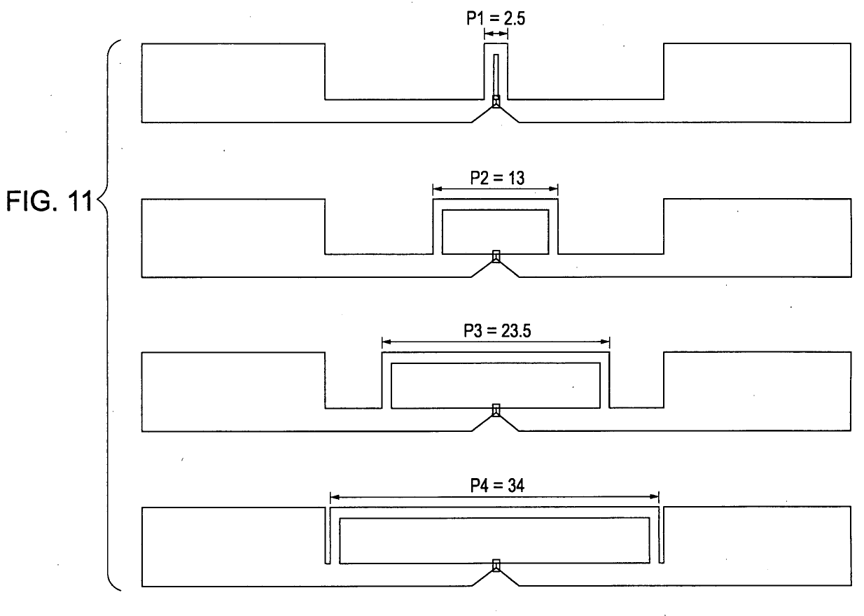

FIG. 11 illustrates an example obtained when the S2 value is changed from P1 to P4.

### <STEP 2>

The antenna optimum value calculating unit 15 determines a local minimum point P5 where a derivative of the third-degree function approximated at STEP 1 becomes substantially equal to 0.

### <STEP 3>

The antenna optimum value calculating unit 15 replaces one of the points P1 to P4 that gives the maximum S11 value by P5.

### <STEP 4>

The antenna optimum value calculating unit 15 repeats the processing of STEPs 1 to 3 using a new set of points P1 to P4 replaced at STEP S4 until the local minimum point converges. If the local minimum point of the third-degree function converges to a constant value, the antenna optimum value calculating unit 15 sets the value as the S2 value.

The minimum and maximum S2 values (P1 and P4) are determined on the basis of a manufacturable minimum pattern interval.

In addition, the well-known Newton's method, the bisection method, or the like may be employed as the algorithm for solving the first-degree equation.

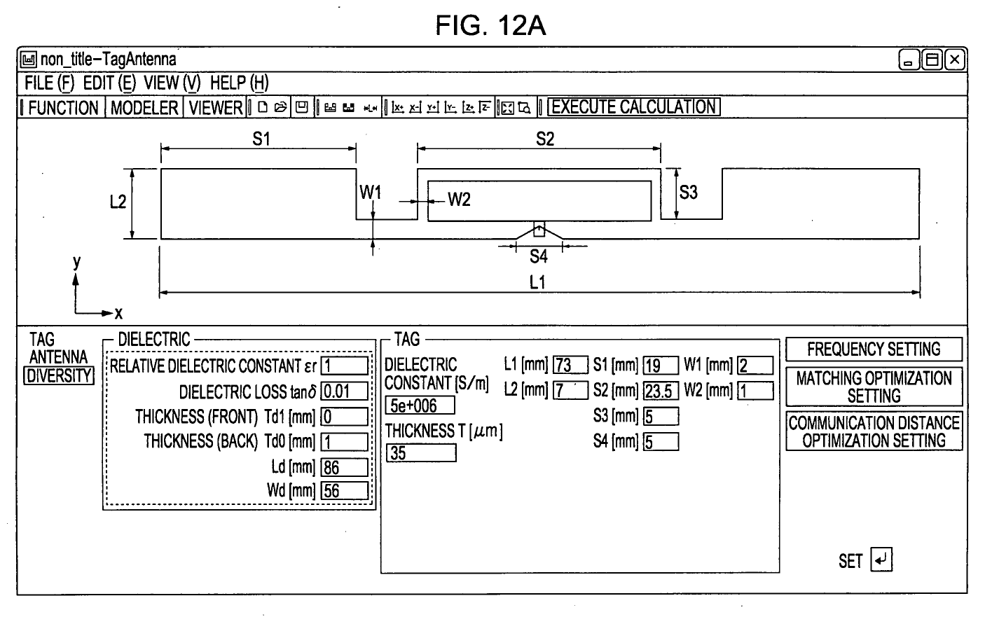

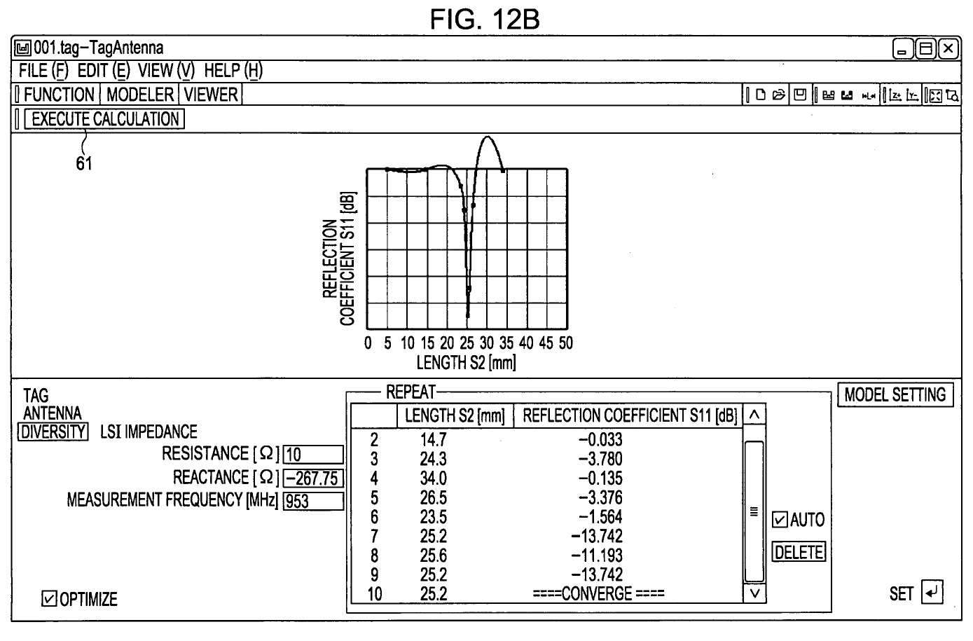

FIGS. 12A and 12B illustrate examples of optimization processing execution screens displayed by the antenna optimum value calculating unit 15.

By inputting characteristic values of the tag LSI on a screen illustrated in FIG. 12B and by pressing an execute calculation button 61 on the screen after specifying the lengths of the tag antenna model other than the S2 on a model creation screen illustrated in FIG. 12A, the algorithm illustrated in FIG. 11 is automatically executed and the optimum S2 value is calculated.

In FIG. 12B, the S2 value converges to 25.2 mm after repetition of the above-described processing of STEPs 1 to 3 ten times, and the optimized S2 value of 25.2 mm is determined under the input conditions.

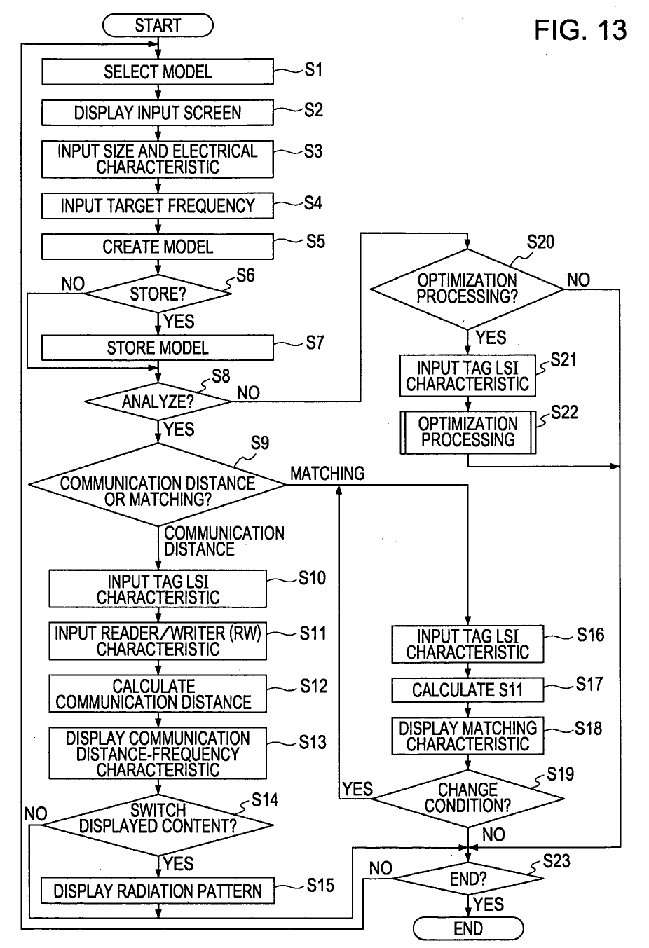

FIG. 13 is a flowchart illustrating an operation of the automatic antenna designing apparatus 1 performed when a tag antenna is designed with the automatic antenna designing apparatus 1 according to this embodiment.

Referring to FIG. 13, after the start of the operation, the design input unit 12 first allows a designer to select a template from types of a tag antenna to be designed at STEP S1. The design input unit 12 then reads out the corresponding template from the model storage unit 11 and displays a screen, which allows the designer to input the shape of the tag antenna illustrated in FIG. 9 as the lengths, at STEP S2. When the designer designs the tag antenna from the start without using the template, the template model is not read out.

At STEP S3, the design input unit 12 allows the designer to input the sizes that define the shape of the tag antenna to be designed and electrical characteristics, such as the conductivity, of the tag antenna and a dielectric to which the tag antenna is adhered on the screen displayed at STEP S2.

At STEP S4, the design input unit 12 then allows the designer to input a target frequency of the tag antenna to be designed on the display screen displayed at STEP S2.

At STEP S5, the design input unit 12 creates a new model on the basis of the content input at STEPs S3 and S4. If the designer chooses to store this created model (YES of STEP S6), the design input unit 12 stores the newly created model in the model storage unit 11 at STEP S7. If the designer chooses not to store the model, the processing at STEP S7 is skipped.

At STEP S8, the design input unit 12 allows the designer to choose whether to analyze the tag antenna model created in the above-described processing.

As a result, if the designer chooses to perform the analysis and performs an input operation in the automatic antenna designing apparatus 1 to notify the apparatus 1 of this choice (YES of STEP S8), the design input unit 12 then allows the designer to choose whether to perform the analysis regarding the communication distance or the matching at STEP S9.

If the designer chooses the analysis of the communication distance and performs an input operation in the automatic antenna designing apparatus 1 to notify the apparatus 1 of this choice at STEP S9 (COMMUNICATION DISTANCE of STEP S9), the automatic antenna designing apparatus 1 activates the communication distance characteristic calculating unit 14. At STEP S10, the communication distance characteristic calculating unit 14 displays the screen illustrated in FIG. 7 and allows the designer to input characteristic information, such as impedance of the tag LSI, at the input block 41. Additionally, at STEP S11, the communication distance characteristic calculating unit 14 allows the designer to input characteristic information of a reader/writer (RW).

At STEP S12, the communication distance characteristic calculating unit 14 calculates a communication distance on the basis of the characteristic of the tag antenna model and the characteristics of the tag LSI and the reader/writer input at STEPs S10 and S11. The communication distance characteristic calculating unit 14 displays a communication distance-frequency characteristic on a screen at STEP S13.

If the designer chooses to switch the displayed content with the communication distance-frequency characteristic being displayed on the screen and performs an input operation in the automatic antenna designing apparatus 1 to notify the apparatus 1 of this choice (YES of STEP S14), the communication distance characteristic calculating unit 14 switches the displayed content from the screen displaying the communication distance-frequency characteristic illustrated in FIG. 7 to the screen displaying the directivity distribution with respect to the communication distance illustrated in FIG. 8 at STEP S15. The process then proceeds to STEP S23. Additionally, if the designer chooses not to switch the display content and performs an input operation in the automatic antenna designing apparatus 1 to notify the apparatus 1 of this choice (NO of STEP S14), the communication distance characteristic calculating unit 14 skips the processing of STEP S15. The process then proceeds to STEP S23.

If the designer chooses the analysis of the matching at STEP S9 (MATCHING of STEP S9), the automatic antenna designing apparatus 1 activates the matching state calculating unit 13. At STEP S16, the matching state calculating unit 13 displays the display screen illustrated in FIG. 4 and allows the designer to input characteristic information, such as impedance of the tag LSI, at the input block 31.

At STEP S17, the matching state calculating unit 13 calculates the S11 value on the basis of the characteristic of the tag antenna model and the characteristic of the tag LSI input at STEP S16. The matching state calculating unit 13 then displays the matching characteristic illustrated in FIG. 4 or 6 so that the designer can visually confirm the matching characteristic at STEP S18.

If the designer changes the condition of the tag LSI and performs an input operation in the automatic antenna designing apparatus 1 to notify the apparatus 1 of re-execution of the analysis (YES of STEP S19), the matching state calculating unit 13 brings the process back to STEP S16. If the designer performs an input operation in the automatic antenna designing apparatus 1 to notify the apparatus 1 of changing the condition of the tag antenna or termination of the operation, the matching state calculating unit 13 brings the process to STEP S23.

If the designer chooses not to perform the analysis and performs an input operation in the automatic antenna designing apparatus 1 to notify the apparatus 1 of this choice at STEP S8 (NO of STEP S20), the automatic antenna designing apparatus 1 allows the designer to choose whether to perform tag antenna optimization processing at STEP S20.

If the designer chooses to perform the optimization processing and performs an input operation in the automatic antenna designing apparatus 1 to notify the apparatus 1 of this choice at STEP S20 (YES of STEP S20), the automatic antenna designing apparatus 1 activates the antenna optimum value calculating unit 15 at STEP S21. At STEP S21, the antenna optimum value calculating unit 15 displays a screen illustrated in FIG. 12 and allows the designer to input the characteristics of the tag LSI.

At STEP S22, the antenna optimum value calculating unit 15 executes the optimization processing described below. The process then proceeds to STEP S23.

Additionally, if the designer chooses not to execute the tag antenna optimization processing and performs an input operation in the automatic antenna designing apparatus 1 to notify the apparatus 1 of this choice at STEP S20 (NO of STEP S20), the antenna optimum value calculating unit 15 advances the process to STEP S23.

At STEP S23, the automatic antenna designing apparatus 1 allows the designer to choose whether to terminate the tag antenna designing operation. If the designer chooses not to terminate the operation and performs an input operation for notifying the apparatus 1 of the choice in the automatic antenna designing apparatus 1 (NO of STEP S23), the automatic antenna designing apparatus 1 brings the process back to STEP S1. In addition, if the designer chooses to terminate the operation and performs an input operation for notifying the apparatus 1 of the choice in the automatic antenna designing apparatus 1 at STEP S23 (YES of STEP S23), the automatic antenna designing apparatus 1 terminates this operation.

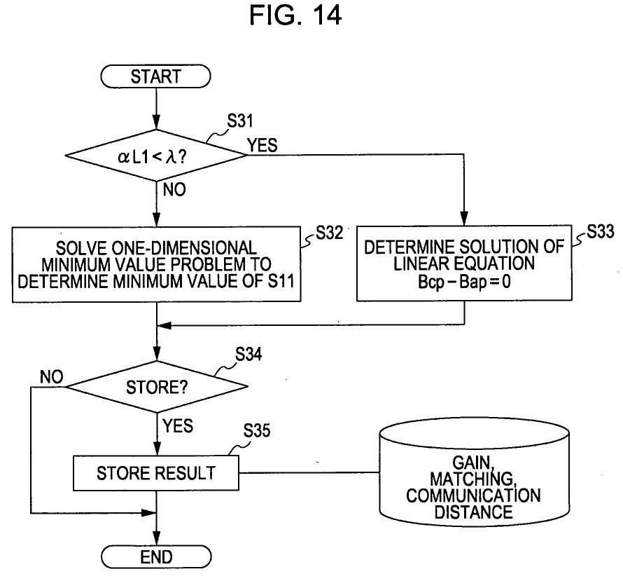

FIG. 14 is a flowchart illustrating a detail of the optimization processing performed at STEP S22 illustrated in FIG. 13.

After the start of the processing illustrated in FIG. 14, the matching state calculating unit 13 determines whether “αL1<λ” is satisfied regarding the length L1 of the tag antenna at STEP S31. Meanwhile, “α” is a given constant and is previously determined by performing preliminary analysis. In addition, “λ” is a wavelength of a radio wave to be received by the tag antenna.

Since the value “α” varies depending on an effective dielectric constant εr of a dielectric to which the tag antenna is adhered, the value “α” is defined as follows.

$$α = \frac{a}{\sqrt{{ɛ}_{r}}}$$

The constant “a” does not depend on the effective dielectric constant εr.

If the matching state calculating unit 13 determines that “αL1<λ” is not satisfied at STEP S31 (NO of STEP S31), the matching state calculating unit 13 determines an S2 value that gives the minimum S11 value by solving the one-dimensional minimum value problem at STEP S32.

In addition, if the matching state calculating unit 13 determines that “αL1<λ” is satisfied at STEP S31 (YES of STEP S31), the matching state calculating unit 13 determines an S2 value that gives the minimum sum of the susceptance of the tag antenna and the susceptance of the tag LSI, that is, the minimum |Bc+Ba| value, namely, an S2 value where Bc−Ba=0 is satisfied, at STEP S33.

After determining the optimized S2 value at STEP S32 or S33, the matching state calculating unit 13 allows the designer to choose whether or not to store this result at STEP S34.

If the designer chooses to store the result and performs an input operation for notifying the apparatus 1 of the choice in the automatic antenna designing apparatus 1 (YES of STEP S34), the matching state calculating unit 13 stores the shape, gain, matching, and communication distance of the optimized tag antenna at STEP S35. The process then proceeds to STEP S23 of FIG. 13. In addition, if the designer chooses not to store the result at STEP S34, the process proceeds to STEP S23.

A case for optimizing a plurality of values that define a shape of a tag antenna will now be described.

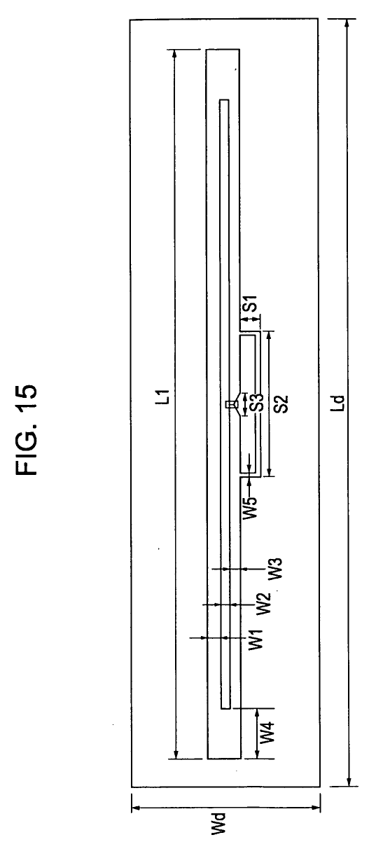

FIG. 15 is a diagram illustrating a first example of a tag antenna automatically designable by optimizing a plurality of values.

FIG. 15 illustrates a tag antenna having a shape in which loop inductance is connected in parallel to a folded dipole antenna.

In the optimization method described using FIGS. 10A to 12B, a case of determining the optimum length S2 on the basis of the communication distance by changing the length S2 is described as an example.

The automatic antenna designing apparatus 1 according to this embodiment can execute optimization processing on a plurality of values instead of optimizing only one length value defining the shape of the above-described antenna.

In addition, in this optimization processing, optimization based on a frequency band can be selected in addition to optimization based on the communication distance.

The type of the tag antenna designable by optimizing one variable illustrated in FIGS. 10A to 12B is limited to non-resonant tag antennas. Additionally, the length S2 that determines the susceptance of the tag antenna is determined on the basis of the result calculated by the antenna optimum value calculating unit 15.

In contrast, when a plurality of values are optimized, a length L1 for determining a resonance characteristic of the tag antenna, a length S2 for determining susceptance of the tag antenna, and lengths W1 and W3 for determining conductance of the tag antenna illustrated in FIG. 14 are determined as the values in the optimization processing performed by the antenna optimum value calculating unit 15. Since the conductance of the tag antenna is determined by a ratio of the length W1 to the length W3, one value may be optimized with the other value being fixed. In addition, since a plurality of variables are handled in the optimization processing of the antenna optimum value calculating unit 15, the most accurate values are calculated using an optimization method, such as the variable metric method (quasi-Newton method).

Other values for determining the shape of the tag antenna are determined on the basis of manufacture conditions rather than the electrical characteristics.

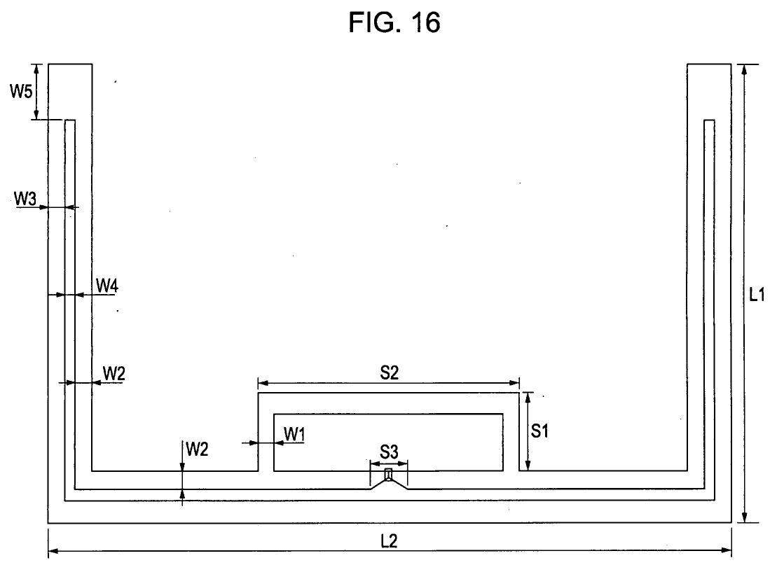

FIG. 16 is a diagram illustrating a second example of a tag antenna automatically designable by optimizing a plurality of values.

A tag antenna of the second example also has a shape in which loop inductance is connected in parallel to a folded dipole antenna. However, in this tag antenna, a folded dipole part is bent to shorten the entire length. Japanese Patent Application No. 2006-548596 discloses an operation principle of this tag antenna.

When this tag antenna is designed, the antenna optimum value calculating unit 15 determines optimized values of lengths L1, S2, W1, and W2 illustrated in FIG. 16. By adjusting the length L1, a resonant frequency is adjusted. In addition, the conductance matching of the tag antenna and the tag LSI is adjusted by adjusting the length S2. The susceptance matching of the tag antenna and the tag LSI is adjusted by adjusting both of or one of the lengths W1 and W3. The optimization is performed by simultaneously changing the parameter values.

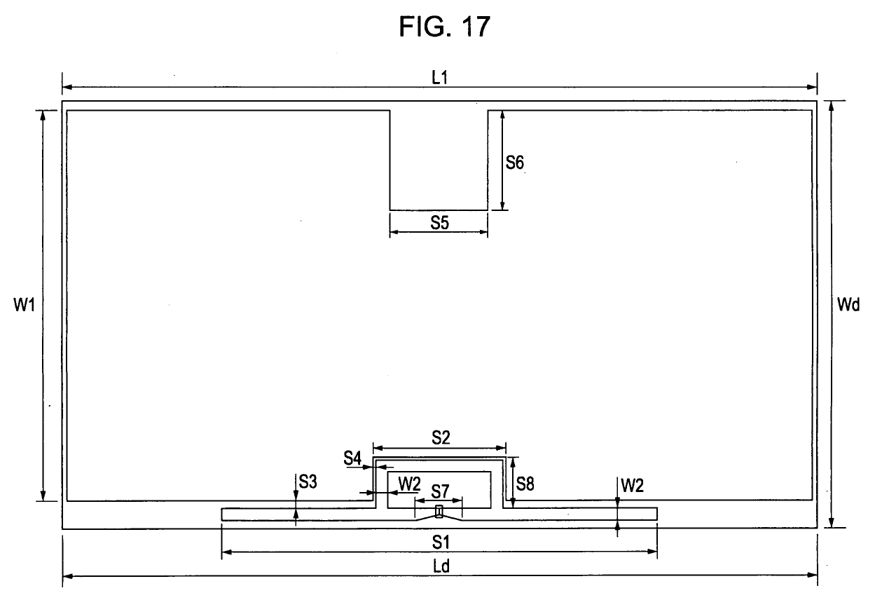

FIG. 17 is a diagram illustrating a third example of a tag antenna automatically designable by optimizing a plurality of values.

The tag antenna of the third example operates even if the tag antenna is adhered to a metal or fluid. In this tag antenna, a feeder pattern and a patch are disposed on one surface of a dielectric and a ground pattern is disposed on another surface. Japanese Unexamined Patent Application Publication No. 2008-67342 discloses an operation principle of such a tag antenna.

To design the tag antenna illustrated in FIG. 17, the antenna optimum value calculating unit 15 determines optimum values of lengths S6, S1 or S2, and S4.

The antenna optimum value calculating unit 15 can adjust a resonant frequency of the antenna by adjusting the length S6. When an electrical length of “L1+2×S6” is equal to a half-wavelength, the antenna resonates and the highest gain is obtained.

The antenna optimum value calculating unit 15 adjusts the matching of the antenna and the tag LSI by adjusting the length S2 or S1. More specifically, susceptance of the antenna changes in response to adjustment of the length S2. As the length S2 increases, the area of the loop pattern increases. Accordingly, inductance L increases. Since the susceptance is inversely proportional to the inductance, the susceptance decreases. In addition, the electrical length of the length S1 is set shorter than the half-wavelength. Admittance rotates clockwise on the Smith chart as the length S1 increases, and the susceptance of the antenna decreases. By adjusting the length S2 so that the susceptance of the tag LSI and the susceptance of the tag antenna are equal in magnitude but opposite in sign, the antenna optimum value calculating unit 15 can adjust the matching of the tag antenna and the tag LSI.

Additionally, the antenna optimum value calculating unit 15 adjusts the matching of the tag antenna and the tag LSI by adjusting the length S4. More specifically, conductance of the antenna changes in response to adjustment of the length S4. The length S4 may be adjusted so that the conductance of the tag LSI becomes substantially equal to the conductance of the tag antenna.

When a tag antenna is designed by optimizing a plurality of lengths that define a shape of a tag antenna in the above-described manner, the designer can choose whether to perform optimization based on a communication distance or a frequency band in the automatic antenna designing apparatus 1 according to this embodiment.

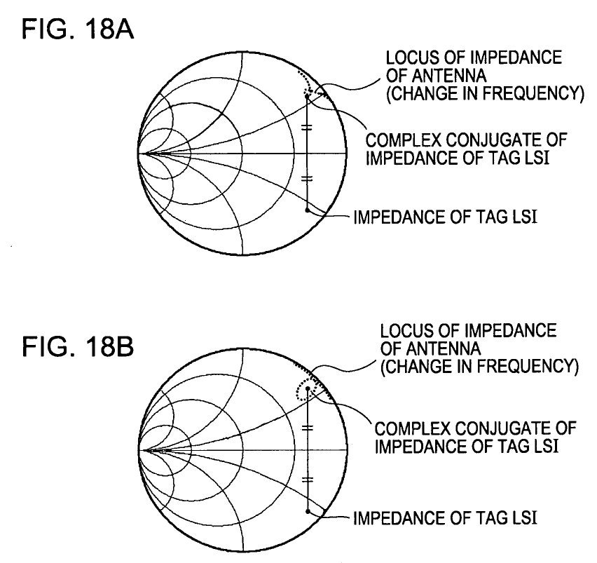

When the antenna is designed on the basis of the communication distance, a locus of impedance (or admittance) of the tag antenna makes one rotation on the Smith chart as illustrated in FIG. 18A when the frequency is changed. At this time, the antenna may be designed so that an apex of the rotation part matches a specification frequency and a complex conjugate of the impedance of the tag LSI.

In addition, when the antenna is designed on the basis of the frequency band, a locus of impedance (or admittance) of the tag antenna makes one rotation on the Smith chart as illustrated in FIG. 18B. At this time, the apex of the rotation part is configured to match the specification frequency and to be located slightly inside relative to the complex conjugate of the impedance of the tag LSI on the Smith chart. That is, the rotation part of the locus of the impedance is configured to surround the complex conjugate of impedance of the tag LSI.

Comparison of the Smith chart focusing on the communication distance illustrated in FIG. 18A and the Smith chart focusing on the frequency band illustrated in FIG. 18B reveals that the impedance of the tag antenna at the operation frequency of the case focusing on the frequency band illustrated in FIG. 18B is further inside than the case focusing the communication distance illustrated in FIG. 18A. This means that the conductance of the antenna is larger and parallel resistance is smaller.

Accordingly, when the designer designs the antenna on the basis of the frequency band, the susceptance of the tag antenna and the susceptance of the tag LSI are configured to be equal in magnitude but opposite in sign, and the conductance of the antenna is configured to be larger than the conductance of the tag LSI. How much the conductance of the antenna is made larger differs depending on the required frequency band.

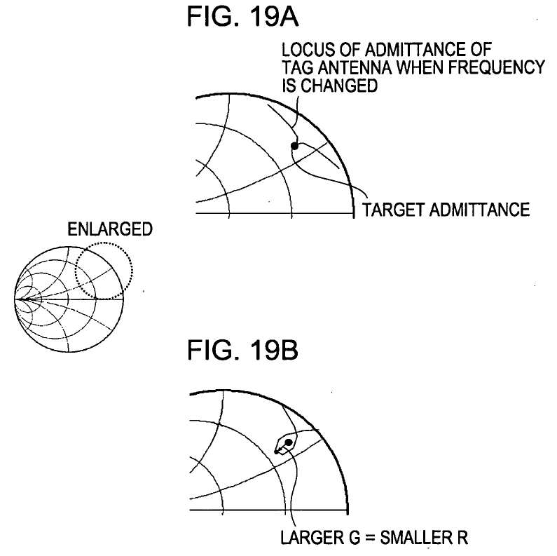

FIG. 19A is an enlarged view of the Smith chart focusing on the communication distance illustrated in FIG. 18A, whereas FIG. 19B is an enlarged view of the Smith chart focusing on the frequency band illustrated in FIG. 18B.

If the gain of the antenna is constant, and the impedance of the antenna matches the impedance of the tag LSI, the communication distance approaches a maximum value.

When the admittance of the antenna and the admittance of the tag LSI are represented as “Ya=Ga+jBa” and “Yc=Gc+jBc,” respectively, and when the tag antenna and the tag LSI are configured to match each other, “Ga=Gc” and “Ba=−Bc” are satisfied.

Here, if “Ga,” the conductance of the tag antenna, is made larger than “Gc,” the conductance of the tag LSI, with “Ba,” the susceptance of the tag antenna, being set equal to “Bc,” the susceptance of the tag LSI, the admittance at an employed frequency is on the inner side of a circle of the locus of the admittance of the tag antenna obtained when the frequency is changed on an admittance chart as illustrated in FIG. 19A.

On the other hand, the length of the locus illustrated in FIG. 19B differs only slightly from that illustrated in FIG. 19A, and the admittance at each frequency approaches target admittance as a whole although the admittance moves away from the target admittance at a peak position. In addition, the admittance moves away from the target admittance at the employed frequency. “Ga” is a reciprocal of resistance Ra (radiation resistance+loss resistance). On the basis of (Ga=1/Ra), when “Ga” becomes larger, the resistance “Ra” becomes smaller. That is, since the matching becomes more preferable when the resistance “Ra” is set slightly smaller (approximately ×0.8 empirically) than the optimum matching, the frequency band broadens.

Accordingly, when the designer performs optimization on the basis of the frequency band, each optimization-target length of the tag antenna is determined while setting the value of the resistance Ra (=1/Ga) slightly smaller (approximately ×0.8 empirically) than that of the case focusing on the communication distance.

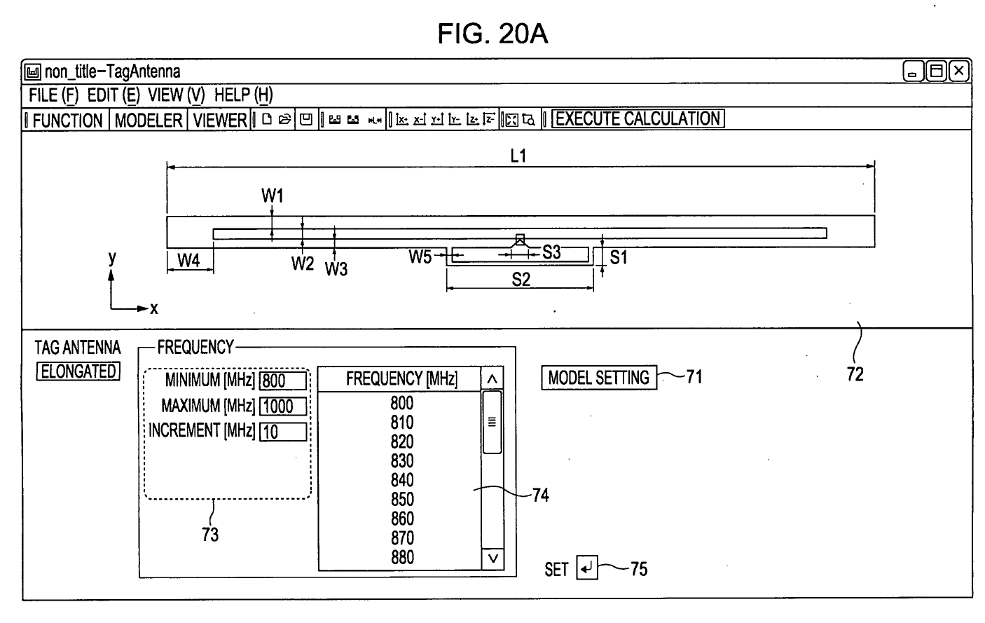

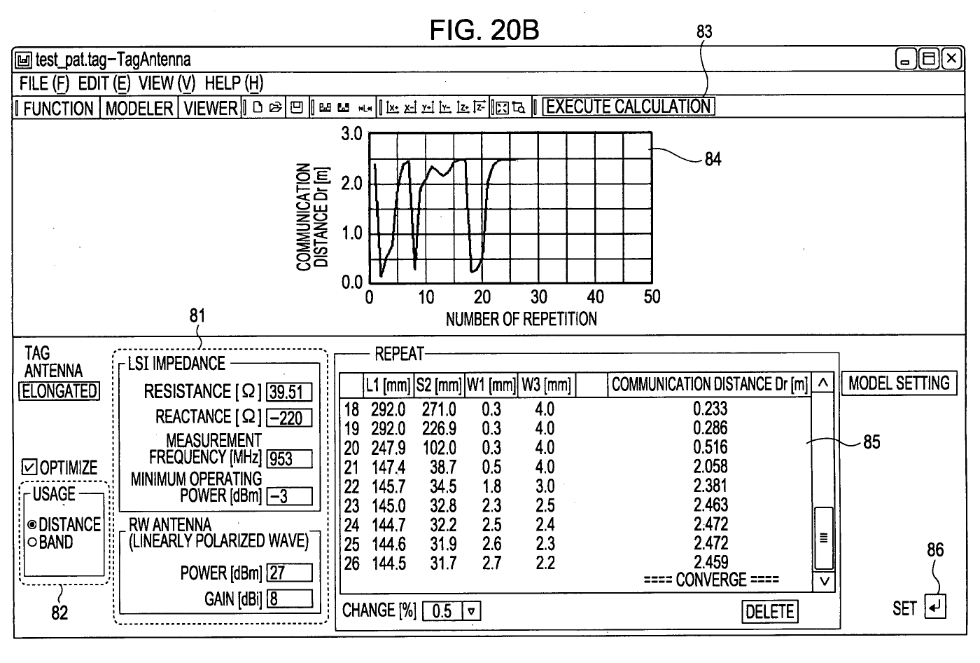

FIG. 20A illustrates an example screen on which an analysis-target frequency range is input when a plurality of lengths defining a tag antenna are optimized.

In the automatic antenna designing apparatus 1 according to this embodiment, in response to selection of a model of a tag antenna to be designed by pressing a model setting button 71, the model of the tag antenna and each length are displayed on a display screen 72. In this state, the apparatus 1 allows the designer to input an analysis-target maximum frequency, an analysis-target minimum frequency, and a frequency increment step at an input block 73 before the antenna optimum value calculating unit 15 determines the optimized values. In response to the designer's input, the analysis-target frequencies are displayed in a frequency output box 74.

In FIG. 20A, optimization processing is performed while the analysis-target frequency is changed by 10 MHZ within a range between 800 MHz and 1000 MHz.

In such a state, if the designer presses a set button 75 on the screen, the screen is switched to a screen illustrated in FIG. 20B.

FIG. 20B illustrates an example setting screen displayed when a plurality of lengths defining the above-described tag antenna are optimized on the basis of the communication distance.

After the screen illustrated in FIG. 20B is displayed, the designer first inputs characteristics of the tag LSI, such as LSI impedance, and characteristics of an RW antenna, such as output power of the RW antenna, at an input block 81. The designer then selects either the distance or the band through a button displayed on the screen and presses an execute calculation button 83.

The antenna optimum value calculating unit 15 determines a plurality of length values defining the shape of the tag antenna using multivariable optimization methods, such as the variable metric method or the conjugate gradient method. The process of this optimization is displayed, to the designer, as a graph 84 on a display screen and as values in a table 85.

Upon determining that each length value determined in this optimization processing is appropriate, the designer presses a set button 86 on the screen, thereby terminating the design process.

A description will now be given for a case where the antenna optimum value calculating unit 15 simultaneously determines optimized values of a plurality of parameters using the variable metric method or the like.

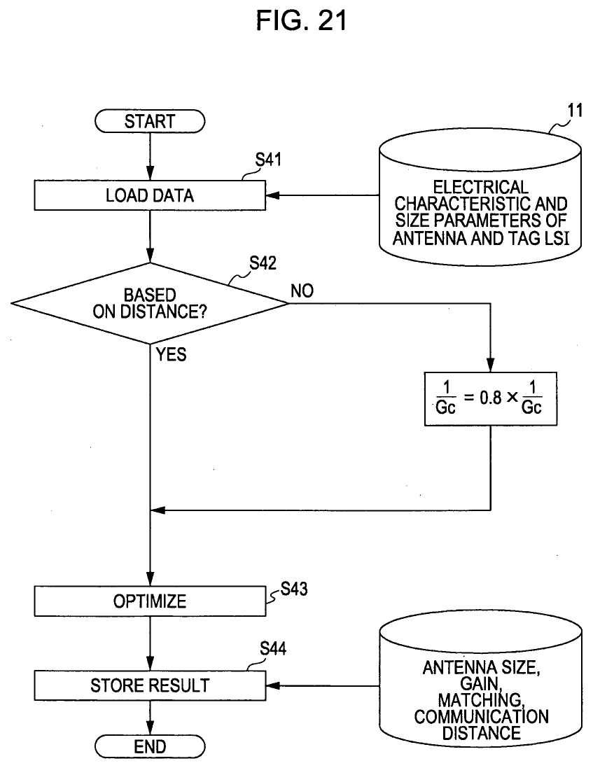

FIG. 21 is a flowchart illustrating an operation of the automatic antenna designing apparatus 1 performed when a plurality of lengths defining a tag antenna are optimally determined at the same time.

The operations illustrated in FIG. 21 represent operations of the design input unit 12 and the antenna optimum value calculating unit 15. Since operations of the matching state calculating unit 13 and the communication distance characteristic calculating unit 14 are basically the same as those described in the flowchart illustrated in FIG. 13, a description thereof is omitted here.

After the start of the operation illustrated in FIG. 21, the design input unit 12 first loads a model serving as a template of a tag antenna to be designed from the model storage unit 11 at STEP S41.

At STEP S42, the design input unit 12 determines whether a setting input by the designer on the screen illustrated in FIG. 20B is a setting based on a communication distance or a frequency band. As a result, if the setting is based on the frequency band (NO of STEP S42), at STEP S43 the design input unit 12 sets a value of 1/Gc to be slightly smaller (×0.8 in this case) than an actual value relative to the conductance Gc of the tag LSI.

In addition, if the setting is based on the communication distance at STEP S42 (YES of STEP S42), the design input unit 12 skips the processing and leaves the 1/Gc value as it is.

The antenna optimum value calculating unit 15 then optimizes length values that form the shape of the tag antenna based on the Gc value set at STEP S42 or S43, using a multiple variable optimization method, such as the variable metric method, at STEP S44. After storing each length defining the shape of the tag antenna, the gain, the matching, and the communication distance resulting from the optimization at STEP S45, the antenna optimum value calculating unit 15 terminates the operation.

In this manner, the automatic antenna designing apparatus 1 according to this embodiment can perform optimization processing on a plurality of values and determine a plurality of optimized values.

A description will now be given for a case where a plurality of values defining a shape of a tag antenna are determined using all of or a partial combination of the bisection method, the Newton's method, and the Brent's method for performing the optimization processing on one parameter.

In this case, a length that determines resonance of a tag antenna, a length that determines susceptance of the tag antenna, and a length that determines conductance of the tag antenna are sequentially determined one by one in optimization processing using the bisection method, the Newton's method, and the Brent's method.

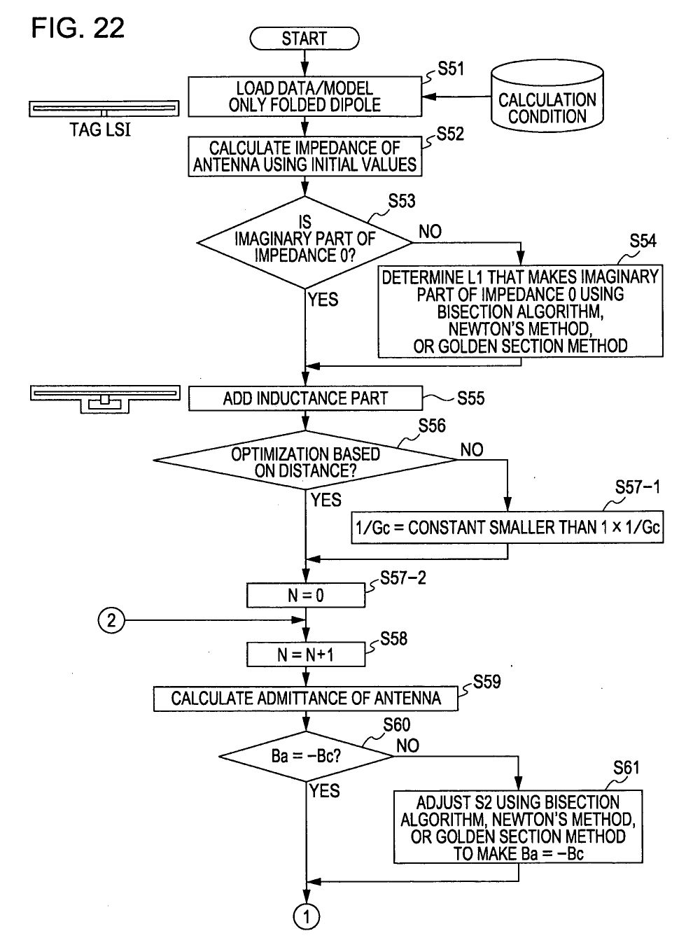

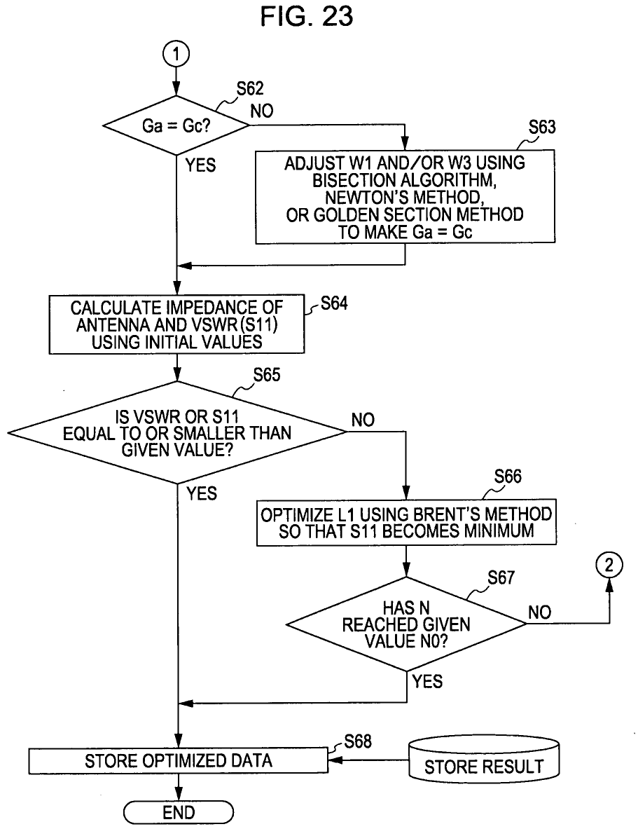

FIGS. 22 and 23 are flowcharts illustrating an operation of the automatic antenna designing apparatus 1 performed when a plurality of values defining a shape of a tag antenna are determined by performing optimization processing for one parameter a plurality of times.

The operation illustrated in FIGS. 22 and 23 represent operations of the design input unit 12 and the antenna optimum value calculating unit 15. Since operations of the matching state calculating unit 13 and the communication distance characteristic calculating unit 14 are basically the same as those described in the flowchart illustrated in FIG. 13, a description thereof is omitted here.

The description below will be given assuming the design of a tag antenna having a shape in which loop inductance is connected in parallel to a folded dipole antenna illustrated in FIG. 15 as an example.

After the start of the operation illustrated in FIG. 22, the design input unit 12 first loads data from the model storage unit 11 and performs modeling of a folded dipole part at STEP S51.

At STEP S52, the antenna optimum value calculating unit 15 then calculates impedance of the antenna using a value of the length L1 given as an initial value of the model.

The antenna optimum value calculating unit 15 then determines whether an imaginary part of the obtained antenna impedance is substantially equal to 0 or not at STEP S53. If the imaginary part is not substantially equal to 0 (NO of STEP S53), the antenna optimum value calculating unit 15 determines a value of the length L1 that makes the imaginary part of the impedance substantially equal to 0 using the bisection method, the Newton's method, or the golden section method at STEP S54. In addition, if the imaginary part of the antenna impedance is substantially equal to 0 at STEP S53 (YES of STEP S53), the value of the length L1 is not problematic. Accordingly, the processing of STEP S54 is skipped.

This value of the length L1 is a temporary value and is temporarily set to increase the speed of convergence in loop processing of STEPs S58 to S67 described later. The final value of the length L1 is determined through the loop processing of STEPs S58 to S67.

Since the value of the length L1 of the folded dipole part is determined, the design input unit 12 adds an inductance part to the model at STEP S55.

The antenna optimum value calculating unit 15 then determines whether the values set by the designer corresponds to a setting for performing optimization based on the communication distance or the frequency band. If the setting is based on the communication distance (YES of STEP S56), the antenna optimum value calculating unit 15 leaves the conductance value Gc of the tag LSI as it is. If the setting is based on the frequency band, the antenna optimum value calculating unit 15 sets the conductance value 1/Gc of the tag LSI equal to a value obtained by multiplying 1/Gc by a constant smaller than 1 (empirically 0.8).

The antenna optimum value calculating unit 15 then initializes to 0 a counter N for counting the number of times of repetition. The antenna optimum value calculating unit 15 increments the counter N by 1 at STEP S58.

The antenna optimum value calculating unit 15 then calculates admittance of the tag antenna at STEP S59. As a result, if a relation between the susceptance Ba of the tag antenna and the susceptance Bc of the tag LSI is “Ba=−Bc” (YES of STEP S60), the antenna optimum value calculating unit 15 leaves the length S2 of the inductance part of the tag antenna as it is. If the relation between the susceptance Ba of the tag antenna and the susceptance Bc of the tag LSI is not “Ba=−Bc” (NO of STEP S60), the antenna optimum value calculating unit 15 adjusts the value of the length S2 using the bisection method, the Newton's method, or the golden section method so that Ba=−Ba is satisfied at STEP S61.

The antenna optimum value calculating unit 15 then determines whether a relation between the conductance value Ga of the tag antenna and the conductance value Gc of the tag LSI is “Ga=Gc” at STEP S62. As a result, if the relation is “Ga=Gc” (YES of STEP S62), the antenna optimum value calculating unit 15 leaves the lengths W1 and/or W3 of the inductance part of the tag antenna as they are. If the relation is not “Ga=Gc” (NO of STEP S62), the antenna optimum value calculating unit 15 adjusts the values of the lengths W1 and/or W3 using the bisection method, the Newton's method, or the golden section method so that Ga=Gc is satisfied at STEP S63.

At STEP S64, the antenna optimum value calculating unit 15 calculates the impedance of the tag antenna and a Voltage Standing Wave Ratio (VSWR) value or an input reflection coefficient using the lengths L1 and S2 optimally determined up to STEP S63 and the initial value.

At STEP S65, the antenna optimum value calculating unit 15 then determines whether the VSWR or S11 value determined at STEP S64 is equal to or smaller than a given value. As a result, if the VSWR or S11 value does not exceed the given value (YES of STEP S65), the process proceeds to STEP S68.

If it is determined that the VSWR or S11 exceeds the given value at STEP S65 (NO of STEP S65), the antenna optimum value calculating unit 15 optimizes the value of the length L1 so that the S11 value becomes minimum at STEP S66.

The antenna optimum value calculating unit 15 then determines the value of the counter N at STEP S67. If the value of the counter N does not reach a given value NO, the process returns to STEP S58. Processing of STEPs S58 to S67 is repeated thereafter until the value of the counter N reaches the given value NO. If the value of the counter N has reached the given value NO (YES of STEP S67), the process proceeds to STEP S68.

At STEP S68, the antenna optimum value calculating unit 15 stores the values of the lengths L1, S2, and W1 or/and W3 optimized in the processing performed until STEP S67 along with the other length values in a memory. The antenna optimum value calculating unit 15 then terminates this operation.

In this manner, the automatic antenna designing apparatus 1 according to this embodiment can determine a plurality of length values defining the shape of the tag antenna in the optimization processing.

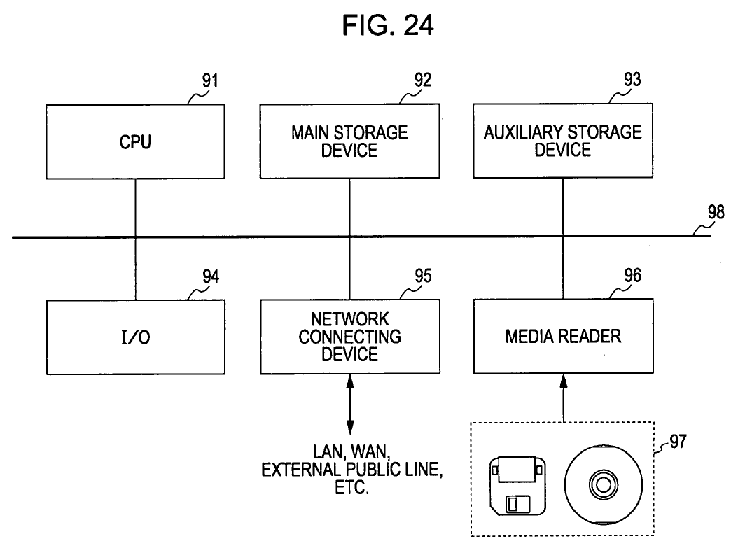

FIG. 24 is a system environment diagram employed when the automatic antenna designing apparatus 1 according to this embodiment is realized as an information processing apparatus, such as a personal computer.

The information processing apparatus illustrated in FIG. 24 includes a central processing unit (CPU) 91; a main storage device 92 such as a random access memory (RAM); an auxiliary storage device 93 such as a hard disk; an input/output (I/O) device 94 such as a display, a keyboard, or a pointing device; a network connecting device 95 such as a modem; and a media reader 96 for reading out stored content from a portable storage medium such as a magnetic tape. These components are connected to each other through a bus 98 and exchange data with each other through the bus 98.

The CPU 91 executes programs stored in the auxiliary storage device 93 and programs installed through the network connecting device 95 using the main storage device 92 as a work area, thereby realizing functions of the components of the automatic antenna designing apparatus 1 illustrated in FIG. 1 and processing of flowcharts illustrated in FIGS. 13, 14, 21, 22, and 23.

In the information processing apparatus illustrated in FIG. 24, the medium reader 96 reads out programs and data stored on a storage medium 97, such as a magnetic tape, a flexible disk, a CD-ROM, an MO, and loads the readout programs and data to a mobile terminal according to this embodiment through an external interface. By executing and using these programs and data in the mobile terminal, the above-described processing illustrated in the flowcharts may be realized with software.

In addition, in the information processing apparatus illustrated in FIG. 24, application software may be exchanged using the storage medium 97, such as a CD-ROM. Accordingly, the disclosed automatic antenna designing apparatus is not limited to an automatic antenna designing apparatus, an automatic antenna designing method, or a program, and may be configured as the computer-readable storage medium 97 for allowing a computer to carry out the above-described functions of the embodiments when the storage medium 97 is used by the computer.

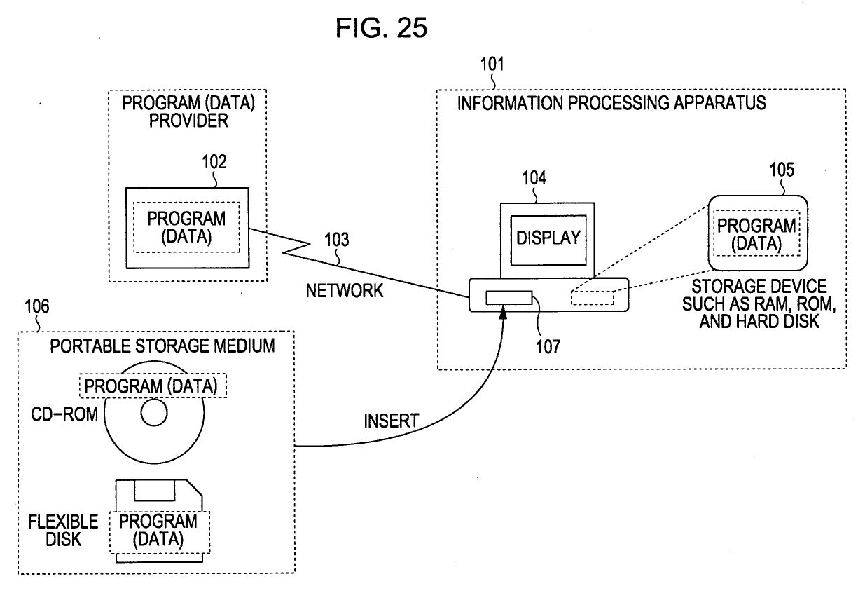

In this case, for example as illustrated in FIG. 25, types of the “storage medium” include a portable storage medium 106, such as a CD-ROM, a flexible disk, an MO, a DVD, a memory card, a removable hard disk, or the like, removably inserted into a medium drive 107, a storage unit (such as a database) 102 included in an external apparatus (such as a server) to which data is transmitted via a network 103, and a memory (such as a RAM or a hard disk) 105 included in a main body 104 of the information processing apparatus 101. Programs stored in the portable storage medium 106 and the storage unit (such as a database) 102 are loaded into the memory (such as a RAM or a hard disk) 105 included in the main body 104 and are executed.

Additionally, regarding the above-described storage medium such as a CD-ROM and a DVD-ROM, the disclosed automatic antenna designing apparatus may be carried out using various mass storage media to be developed hereafter, such as next-generation optical disk storage media using blue laser, e.g., a Blu-ray Disc and an Advanced Optical Disc (AOD), an HD-DVD9 using red laser, a Blue Laser DVD using blue-violet laser, or hologram, in addition to the media cited as examples above.

According to the disclosed automatic antenna designing apparatus, since templates of a tag antenna model to be designed are prepared, a designer can create the model by simply inputting information regarding lengths of parts that the designer wants to change. Accordingly, efficiency of creation of the model is remarkably improved compared to a conventional case of creating a model by inputting coordinates on an input screen.

In addition, since the automatic antenna designing apparatus has a function for calculating a matching characteristic of a tag antenna and a tag LSI under a specified condition regarding the tag LSI, the matching state can be evaluated quantitatively.

Furthermore, since the automatic antenna designing apparatus has a function for calculating a communication distance using specified characteristics of a tag LSI and a reader/writer (RW), design efficiency is remarkably improved compared with a conventional case of separately calculating the communication distance using spreadsheet software on the basis of an analysis result obtained with an electromagnetic field simulator.

In addition, the automatic antenna designing apparatus may design a tag antenna optimized under a given condition and may display the result.

Furthermore, the automatic antenna designing apparatus may determine a plurality of lengths that define a shape of an antenna in optimization processing.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments have been described in detail, it should be understood that the various changes, substitutions, and alterations could be made hereto without departing from the spirit and scope of the invention.

Regarding the embodiments described above, following additional descriptions are disclosed.

Additional Description 1

An automatic antenna designing apparatus for designing a tag antenna of an IC (Integrated Circuit) tag, comprising: a model storage unit configured to store models serving as templates of the tag antenna to be designed; and a design input unit configured to read out a model from the model storage unit on the basis of a designer's instruction, to display the read out model on a screen, and to display an input screen allowing the designer to input a change in a shape of the model as length information.

Additional Description 2

An automatic antenna designing method for designing a tag antenna of an IC tag, comprising: displaying a shape of the tag antenna to be designed on a screen; and displaying an input screen for allowing a designer to input a change in the shape of the tag antenna to be designed as length information.

Additional Description 3

A computer-readable storage medium storing a program to be executed by an information processing apparatus including a computer, the program allowing the information processing apparatus to execute a method, the method comprising: displaying a shape of a tag antenna of an IC tag to be designed on a screen; and displaying an input screen for allowing a designer to input a change in the shape of the tag antenna to be designed as length information.

Additional Description 4

The computer-readable storage medium storing the program according to Additional Description 3, the program allowing the information processing apparatus to execute the method, the method further comprising: changing the shape of the tag antenna to be designed displayed on the screen on the basis of the length information input on the input screen that allows the designer to input the change in the shape as the length information.

Additional Description 5

The computer-readable storage medium storing the program according to Additional Description 3, the program allowing the information processing apparatus to execute the method, the method further comprising: reading out a model from a model storage unit on the basis of a designer's instruction and displaying the read out model on a screen.

Additional Description 6

The computer-readable storage medium storing the program according to Additional Description 3, the program allowing the information processing apparatus to execute the method, the method further comprising: allowing the designer to input impedance of a tag LSI of the IC tag; calculating a matching characteristic of the tag antenna to be designed and the tag LSI using the impedance of the tag LSI; and displaying the matching characteristic.

Additional Description 7

The computer-readable storage medium storing the program according to Additional Description 3, the program allowing the information processing apparatus to execute the method, the method further comprising: allowing the designer to input impedance of a tag LSI of the IC tag; allowing the designer to input a characteristic of a reader/writer that reads out data from and writes data in the IC tag; determining a communication distance of the tag antenna to be designed using the impedance of the tag LSI and the characteristic of the reader/writer; and displaying the communication distance.

Additional Description 8

The computer-readable storage medium storing the program according to Additional Description 7, wherein displaying of the communication distance is displaying of a frequency characteristic with respect to the communication distance.

Additional Description 9

The computer-readable storage medium storing the program according to Additional Description 7, wherein displaying of the communication distance is displaying of a directivity distribution with respect to the communication distance.

Additional Description 10

The computer-readable storage medium storing the program according to Additional Description 3, the program allowing the information processing apparatus to execute the method, the method further comprising: changing an antenna optimization method in accordance with a length L1 of the tag antenna to be designed relative to a wavelength λ of a reception-target radio wave.

Additional Description 11

The computer-readable storage medium storing the program according to Additional Description 10, the program allowing the information processing apparatus to execute the method, the method further comprising: performing antenna optimization using a first algorithm when a relation between the wavelength λ and the length L1 of the tag antenna with respect to a constant α is “αL1<λ” and performing antenna optimization using a second algorithm when the relation is not “αL1<λ”.

Additional Description 12

The computer-readable storage medium storing the program according to Additional Description 3, the program allowing the information processing apparatus to execute the method, the method further comprising: displaying an input screen that allows the designer to input a characteristic of a material to which the tag antenna to be designed is adhered.

Additional Description 13

The computer-readable storage medium storing the program according to Additional Description 3, the program allowing the information processing apparatus to execute the method, the method further comprising: displaying an input screen that allows the designer to input an electrical characteristic of the tag antenna to be designed.

Additional Description 14

The computer-readable storage medium storing the program according to Additional Description 3, the program allowing the information processing apparatus to execute the method, the method further comprising: determining a characteristic of the tag antenna to be designed in consideration of the shape and electrical characteristic of the tag antenna to be designed and a characteristic of a material to which the tag antenna to be designed is adhered.

Additional Description 15

The computer-readable storage medium storing the program according to Additional Description 3, the program allowing the information processing apparatus to execute the method, the method further comprising: determining a plurality of length values that define the shape of the tag antenna in optimization processing.

Additional Description 16

The computer-readable storage medium storing the program according to Additional Description 15, wherein the plurality of length values include at least one of a length value that determines resonance of the tag antenna, a length value that determines susceptance of the tag antenna, and a length value that determines conductance of the tag antenna.

Additional Description 17

The computer-readable storage medium storing the program according to Additional Description 15, the program allowing the information processing apparatus to execute the method, the method further comprising: selecting whether to perform the optimization processing on the basis of a distance or a band in accordance with a designer's instruction.

Additional Description 18

The computer-readable storage medium storing the program according to Additional Description 17, the program allowing the information processing apparatus to execute the method, the method further comprising: setting, when performing the optimization processing on the basis of the band, conductance of the tag LSI to be smaller than conductance employed in the optimization processing based on the distance.

Additional Description 19

The computer-readable storage medium storing the program according to Additional Description 15, the program allowing the information processing apparatus to execute the method, the method further comprising: performing the optimization processing using the variable metric method.

Additional Description 20

The computer-readable storage medium storing the program according to Additional Description 15, the program allowing the information processing apparatus to execute the method, the method further comprising: performing the optimization processing using at least one of the bisection method, the Newton's method, and the Brent's method.

What is claimed is:

1. An automatic antenna designing apparatus for designing a tag antenna of an IC tag, comprising:
a model storage unit configured to store models serving as templates of the tag antenna to be designed; and
a design input unit configured to read out a model from the model storage unit on the basis of a designer's instruction, to display the read out model on a screen, and to display an input screen allowing the designer to input a change in a shape of the model as length information.

2. An automatic antenna designing method for designing a tag antenna of an IC tag, comprising:
displaying a shape of the tag antenna to be designed on a screen; and
displaying an input screen for allowing a designer to input a change in the shape of the tag antenna to be designed as size information.

3. A computer-readable storage medium storing a program to be executed by an information processing apparatus including a computer, the program allowing the information processing apparatus to execute a method, the method comprising:
displaying a shape of a tag antenna of an IC tag to be designed on a screen; and
displaying an input screen for allowing a designer to input a change in the shape of the tag antenna to be designed as size information.

4. The computer-readable storage medium storing the program according to claim 3, the program allowing the information processing apparatus to execute the method, the method further comprising:
changing the shape of the tag antenna to be designed displayed on the screen on the basis of the size information input on the input screen that allows the designer to input the change in the shape as the size information.

5. The computer-readable storage medium storing the program according to claim 3, the program allowing the information processing apparatus to execute the method, the method further comprising:
reading out a model from a model storage unit on the basis of a designer's instruction and displaying the read out model on a screen.

6. The computer-readable storage medium storing the program according to claim 3, the program allowing the information processing apparatus to execute the method, the method further comprising:
allowing the designer to input impedance of a tag LSI of the IC tag;
calculating a matching characteristic of the tag antenna to be designed and the tag LSI using the impedance of the tag LSI; and
displaying the matching characteristic.

7. The computer-readable storage medium storing the program according to claim 3, the program allowing the information processing apparatus to execute the method, the method further comprising:
allowing the designer to input impedance of a tag LSI of the IC tag;
allowing the designer to input a characteristic of a reader/writer that reads out data from and writes data in the IC tag;
determining a communication distance of the tag antenna to be designed using the impedance of the tag LSI and the characteristic of the reader/writer; and
displaying the communication distance.

8. The computer-readable storage medium storing the program according to claim 7, wherein displaying of the communication distance is displaying a frequency characteristic with respect to the communication distance.

9. The computer-readable storage medium storing the program according to claim 7, wherein displaying the communication distance is displaying a directivity distribution with respect to the communication distance.

10. The computer-readable storage medium storing the program according to claim 3, the program allowing the information processing apparatus to execute the method, the method further comprising:
changing an antenna optimization method in accordance with a length L1 of the tag antenna to be designed relative to a wavelength λ of a reception-target radio wave.

11. The computer-readable storage medium storing the program according to claim 10, the program allowing the information processing apparatus to execute the method, the method further comprising:
performing antenna optimization using a first algorithm when a relation between the wavelength λ and the length L1 of the tag antenna with respect to a constant α is “αL1<λ” and performing antenna optimization using a second algorithm when the relation is not “αL1<λ”.

12. The computer-readable storage medium storing the program according to claim 3, the program allowing the information processing apparatus to execute the method, the method further comprising:
displaying an input screen that allows the designer to input a characteristic of a material to which the tag antenna to be designed is adhered.

13. The computer-readable storage medium storing the program according to claim 3, the program allowing the information processing apparatus to execute the method, the method further comprising:
displaying an input screen that allows the designer to input an electrical characteristic of the tag antenna to be designed.

14. The computer-readable storage medium storing the program according to claim 3, the program allowing the information processing apparatus to execute the method, the method further comprising:
determining a characteristic of the tag antenna to be designed in consideration of the shape and electrical characteristic of the tag antenna to be designed and a characteristic of a material to which the tag antenna to be designed is adhered.

15. The computer-readable storage medium storing the program according to claim 3, the program allowing the information processing apparatus to execute the method, the method further comprising:
determining a plurality of values that define the shape of the tag antenna in optimization processing.

16. The computer-readable storage medium storing the program according to claim 15, wherein the plurality of values include at least one of a value that determines resonance of the tag antenna, a value that determines susceptance of the tag antenna, and a value that determines conductance of the tag antenna.

17. The computer-readable storage medium storing the program according to claim 15, the program allowing the information processing apparatus to execute the method, the method further comprising:
selecting whether to perform the optimization processing on the basis of a distance or a band in accordance with a designer's instruction.

18. The computer-readable storage medium storing the program according to claim 17, the program allowing the information processing apparatus to execute the method, the method further comprising:
setting, when performing the optimization processing on the basis of the band, conductance of the tag LSI to be smaller than conductance employed in the optimization processing based on the distance.

19. The computer-readable storage medium storing the program according to claim 15, the program allowing the information processing apparatus to execute the method, the method further comprising:
performing the optimization processing using the variable metric method.

20. The computer-readable storage medium storing the program according to claim 15, the program allowing the information processing apparatus to execute the method, the method further comprising:
performing the optimization processing using at least one of the bisection method, the Newton's method, and the Brent's method.
